(19) United States
(12) Patent Application Publication
(10) Pub. No.: US 2025/0219719 A1
(43) Pub. Date: Jul. 3, 2025

(54) COMMUNICATION METHOD AND APPARATUS

(71) Applicant: HUAWEI TECHNOLOGIES CO., LTD., Shenzhen (CN)

(72) Inventors: Yu WANG, Hangzhou (CN); Hejia LUO, Hangzhou (CN); Yunfei QIAO, Hangzhou (CN); Chuili KONG, Hangzhou (CN); Jun WANG, Hangzhou (CN)

(21) Appl. No.: 19/065,031

(22) Filed: Feb. 27, 2025

Related U.S. Application Data
(63) Continuation of application No. PCT/CN2023/103164, filed on Jun. 28, 2023.

(30) Foreign Application Priority Data
Aug. 30, 2022 (CN) 202211051001.X

(51) Int. Cl. H04B 7/185; H04W 36/08

(52) U.S. Cl. CPC H04B 7/18519; H04W 36/08

(57) ABSTRACT

This application provides a communication method and apparatus, to resolve a problem of a limited processing capability of a satellite and improve communication efficiency. The communication method and apparatus are applicable to a communication system. The method includes a first device obtaining first information and sending the first information to a first satellite. The first information is generated by a first protocol entity of the first device, and the first protocol entity of the first device corresponds to a first protocol entity of a second device. The first satellite is a satellite that is in a plurality of satellites and that provides a network service for the second device, and the plurality of satellites correspond to one logical cell.

### CROSS-REFERENCE TO RELATED APPLICATIONS

This application is a continuation of International Application No. PCT/CN2023/103164, filed on Jun. 28, 2023, which claims priority to Chinese Patent Application No. 202211051001.X, filed on Aug. 30, 2022. The disclosures of the aforementioned applications are hereby incorporated by reference in their entireties.

### TECHNICAL FIELD

This application relates to the communication field, and in particular, to a communication method and apparatus.

### BACKGROUND

In a communication system of a non-terrestrial network, data or signaling needs to pass through a terrestrial station and a satellite in a transmission process. Due to limited load of the satellite, a processing capability of the satellite is limited. Therefore, in the process of transmitting the data via the satellite, information transmission and processing delays are high. How to simplify the data transmission process to improve communication efficiency is an urgent problem to be resolved.

### SUMMARY

Embodiments of this application provide a communication method and apparatus, to resolve a problem of a limited processing capability of a satellite and improve communication efficiency.

To achieve the foregoing objective, the following technical solutions are used in this application.

According to a first aspect, a communication method is provided. The communication method includes: A first device obtains first information and sends the first information to a first satellite. The first information is generated by a first protocol entity of the first device, and the first protocol entity of the first device corresponds to a first protocol entity of a second device. The first satellite is a satellite that is in a plurality of satellites and that provides a network service for the second device, and the plurality of satellites correspond to one logical cell.

In this way, the first device may generate the first information by using the first protocol entity of the first device, and send the first information to the first satellite, where the first protocol entity of the first device corresponds to the first protocol entity of the second device. In this way, the first protocol entity of the first device and the first protocol entity of the second device may process information, to avoid processing data by the first satellite, so that processing complexity in a data transmission process can be reduced, and communication efficiency can be improved.

In a possible implementation solution, the first information may be for performing mobility management of the second device. In this way, in a dynamic network (for example, a low-orbit satellite network) environment, when a moving range of the second device is small, cell reselection, cell handover, system message update, registration area update, and other operations do not need to be performed frequently, so that a mobility management procedure of a network can be simplified, and signaling overheads for mobility management are reduced.

For example, the first device is a network device, and the second device is a terminal device.

Optionally, the first protocol entity of the first device may include a radio resource control (RRC) entity. The first information is generated by the RRC entity. In this way, when the terminal device does not move out of a coverage area of the network device, the terminal device does not need to frequently update and reconfigure an RRC message, to reduce signaling overheads and power consumption of the terminal device.

In a possible implementation solution, the first information may include one or more of the following: a synchronization signal and physical broadcast channel block (SSB)-based measurement timing configuration (SMTC) corresponding to each of the plurality of satellites, a time offset of the SMTC, ephemeris information of a satellite corresponding to a satellite that provides a network service for the second device within a first time length, a first distance threshold for determining whether the second device performs registration area update, time at which the second device performs satellite reselection, time at which the second device performs satellite switching, a location at which the second device performs satellite reselection, a location at which the second device performs satellite switching, and paging configuration information of the second device in the cell corresponding to the plurality of satellites.

Optionally, the first protocol entity of the first device may include a non-access stratum (NAS) entity, and the first information is generated by the NAS entity.

Further, the first information may include registration area update information. The registration area update information indicates whether a registration area of the second device is successfully updated.

Further, before the first device sends the first information to the first satellite, the method provided in the first aspect may further include: The first device receives second information from the first satellite, and processes the second information by using the NAS entity. The second information indicates to update a location of the second device. In this way, the first device can update the location of the second device in a timely manner, to maintain the latest location information of the second device in a timely manner, and improve paging reliability and reduce paging resource overheads.

In a possible implementation solution, the first protocol entity of the first device may include a service data adaptation protocol (SDAP) entity. In this way, service data can be processed.

In a possible implementation solution, the first protocol entity of the first device may further include a packet data convergence protocol (PDCP) entity.

In a possible implementation solution, the first protocol entity of the first device may further include a radio link control (RLC) entity.

In a possible implementation solution, coverage areas of the cells corresponding to the plurality of satellites are different. Alternatively, frequencies respectively used by the plurality of satellites to send SSBs are different.

According to a second aspect, a communication method is provided. The communication method includes: A first satellite receives first information from a first device. The first satellite is a satellite that is in a plurality of satellites and that provides a network service for a second device, and the plurality of satellites correspond to one logical cell. The first satellite sends the first information to the second device.

In a possible implementation solution, the first information may be for performing mobility management of the second device.

In a possible implementation solution, the first information may include one or more of the following: a synchronization signal and physical broadcast channel block SSB-based measurement timing configuration SMTC corresponding to each of the plurality of satellites, a time offset of the SMTC, ephemeris information of a satellite corresponding to a cell that provides a network service for the second device within a first time length, a first distance threshold for determining whether the second device performs registration area update, time at which the second device performs satellite reselection, time at which the second device performs satellite switching, a location at which the second device performs satellite reselection, a location at which the second device performs satellite switching, and paging configuration information of the second device in the cell corresponding to the plurality of satellites.

In a possible implementation solution, the first information may include registration area update information. The registration area update information indicates whether a registration area of the second device is successfully updated.

Further, before the first satellite sends the first information to the second device, the method provided in the second aspect may further include: The first satellite sends second information to the first device. The second information indicates to update a location of the second device.

In a possible implementation solution, coverage areas of the cells corresponding to the plurality of satellites are different. Alternatively, frequencies respectively used by the plurality of satellites to send SSBs are different.

In addition, for technical effects of the communication apparatus in the second aspect, refer to the technical effects of the communication method in the first aspect.

According to a third aspect, a communication method is provided. The communication method may include: A second device receives first information from a first satellite. The first satellite is a satellite that is in a plurality of satellites and that provides a network service for the second device, and the plurality of satellites correspond to one logical cell. The second device processes the first information by using a first protocol entity of the second device. The first protocol entity of the second device corresponds to a first protocol entity of a first device.

In a possible implementation solution, the first information is for performing mobility management of the second device.

Optionally, the first protocol entity of the second device may include a radio resource control protocol RRC entity. That the second device processes the first information by using the first protocol entity of the second device may include: The second device processes the first information by using the RRC entity.

In a possible implementation solution, the first information may include: a synchronization signal and physical broadcast channel block SSB-based measurement timing configuration SMTC corresponding to each of the plurality of satellites, a time offset of the SMTC, ephemeris information of a satellite corresponding to a cell that provides a network service for the second device within a first time length, a first distance threshold for determining whether the second device performs registration area update, time at which the second device performs satellite reselection, time at which the second device performs satellite switching, a location at which the second device performs satellite reselection, a location at which the second device performs satellite switching, and paging configuration information of the second device in the cell corresponding to the plurality of satellites.

In a possible implementation solution, the first protocol entity of the second device may include a non-access stratum NAS entity. That the second device processes the first information by using the first protocol entity of the second device may include: The second device processes the first information by using the NAS entity.

Further, the first information may include registration area update information. The registration area update information indicates whether a registration area of the second device is successfully updated.

Further, before the second device receives the first information from the first satellite, the method provided in the third aspect may further include: The second device sends second information to the first satellite. The second information indicates to update a location of the second device.

In a possible implementation solution, the communication method provided in the third aspect may further include: The second device performs mobility management based on the first information.

In a possible implementation solution, the first protocol entity of the second device may include a service data adaptation protocol SDAP entity.

In a possible implementation solution, the first protocol entity of the second device may further include a packet data convergence protocol PDCP entity.

In a possible implementation solution, the first protocol entity of the second device may further include a radio link control RLC entity.

In a possible implementation solution, coverage areas of the cells corresponding to the plurality of satellites are different. Alternatively, frequencies respectively used by the plurality of satellites to send SSBs are different.

In addition, for technical effects of the communication apparatus in the third aspect, refer to the technical effects of the communication method in the first aspect.

According to a fourth aspect, a communication method is provided. The communication method includes: A second satellite obtains third information. The second satellite is a satellite that currently provides a network service for a terminal device in a first area, the third information is information indicating a third satellite to provide a network service for the terminal device in the first area, and the third information is related to ephemeris information of the third satellite. The second satellite sends the third information to the third satellite.

According to the communication method provided in the fourth aspect, the second satellite may obtain the third information, and send the third information to the third satellite, where the third information is the information indicating the third satellite to provide the network service for the terminal device that is in the first area and for which the second satellite currently provides the network service, and the third information is related to the ephemeris information of the third satellite. In this way, different satellites may collaboratively provide network services for a same area by using the third information, so that communication efficiency can be improved.

In a possible implementation solution, the third information may include one or more of the following: routing information used by the third satellite to provide a network service for the first area, identification information of the first area, or a time period in which the second satellite provides a service for the first area. In this way, service time and service areas of different satellites can be coordinated, and interference in a coordinated coverage area is reduced.

In a possible implementation solution, that the second satellite sends the third information to the third satellite may include: The second satellite sends the third information to the third satellite through a transmission reception node interface protocol (TRP-AP) interface. In this way, the third information may be transmitted through the new interface, to improve flexibility of information transmission.

Optionally, the method provided in the fourth aspect may further include: The second satellite receives fourth information from the third satellite through the TRP-AP interface. The fourth information indicates a feedback result of the third satellite for the third information. In this way, the second satellite may obtain the feedback result of the third information, so that communication reliability can be further improved.

In a possible implementation solution, that the second satellite sends the third information to the third satellite may include: The second satellite sends the third information to the third satellite through an Xn interface. In this way, information transmission can be performed between the second satellite and the third satellite by reusing the existing interface, so that development costs of a new interface can be reduced.

In a possible implementation solution, the third information may further include: first identification information of the terminal device, a time-frequency resource used by the third satellite to provide the network service for the terminal device, the ephemeris information of the third satellite, measurement configuration information of the third satellite, second identification information of the third satellite, SSB information of the third satellite, a frequency of the third satellite, polarization information of the third satellite, a reference point location of the third satellite, and information for synchronization between the second satellite and the third satellite.

According to a fifth aspect, a communication method is provided. The communication method includes: A third satellite receives third information from a second satellite. The second satellite is a satellite that currently provides a network service for a terminal device in a first area. The third information is information indicating the third satellite to provide a network service for the terminal device in the first area, and the third information is related to ephemeris information of the third satellite. The third satellite sends fourth information to the second satellite. The fourth information indicates a feedback result of the third satellite for the third information.

In a possible implementation solution, the third information may include one or more of the following: routing information used by the third satellite to provide a network service for the first area, identification information of the first area, or a time period in which the second satellite provides a service for the first area.

In a possible implementation solution, that the third satellite receives the third information from the second satellite may include: The third satellite receives the third information from the second satellite through a transmission reception node interface protocol TRP-AP interface.

Optionally, that the third satellite sends the fourth information to the second satellite may include: The third satellite sends the fourth information to the second satellite through the TRP-AP interface.

In a possible implementation solution, that the third satellite receives the third information from the second satellite may include: The third satellite receives the third information from the second satellite through an Xn interface.

In a possible implementation solution, the third information may further include: first identification information of the terminal device, a time-frequency resource used by the third satellite to provide the network service for the terminal device, the ephemeris information of the third satellite, measurement configuration information of the third satellite, second identification information of the third satellite, SSB information of the third satellite, a frequency of the third satellite, polarization information of the third satellite, a reference point location of the third satellite, and information for synchronization between the second satellite and the third satellite.

According to a sixth aspect, this application provides a communication apparatus, to implement the communication method in any one of the implementations of the first aspect to the fifth aspect.

In this application, the communication apparatus in the sixth aspect may be the network device in the first aspect, the satellite in any one of the second aspect, the fourth aspect, or the fifth aspect, the terminal device in the third aspect, a chip (system) or another part or component that may be disposed in the terminal device, the satellite, or the network device, or an apparatus including the terminal device, the satellite, or the network device.

It should be understood that the communication apparatus in the sixth aspect includes a corresponding module, unit, or means for implementing the communication method in any one of the first aspect to the fifth aspect. The module, the unit, or the means may be implemented by hardware, may be implemented by software, or may be implemented by hardware executing corresponding software. The hardware or the software includes one or more modules or units configured to perform functions related to the foregoing communication methods.

In addition, for technical effects of the communication apparatus in the sixth aspect, refer to the technical effects of the communication method in any one of the first aspect to the fifth aspect.

According to a seventh aspect, a communication apparatus is provided. The communication apparatus includes a processor, and the processor is configured to perform the communication method in any one of the possible implementations of the first aspect to the fifth aspect.

In a possible implementation solution, the communication apparatus in the seventh aspect may further include a transceiver. The transceiver may be a transceiver circuit or an interface circuit. The transceiver may be used by the communication apparatus in the seventh aspect to communicate with another communication apparatus.

In a possible implementation solution, the communication apparatus in the seventh aspect may further include a memory. The memory and the processor may be integrated together, or may be disposed separately. The memory may be configured to store a computer program and/or data related to the communication method in any one of the first aspect to the fifth aspect.

In this application, the communication apparatus in the seventh aspect may be the network device in the first aspect, the satellite in any one of the second aspect, the fourth aspect, or the fifth aspect, the terminal device in the third aspect, a chip (system) or another part or component that may be disposed in the terminal device, the satellite, or the network device, or an apparatus including the terminal device, the satellite, or the network device.

According to an eighth aspect, a communication apparatus is provided. The communication apparatus includes a processor. The processor is coupled to a memory, and the processor is configured to execute a computer program stored in the memory, so that the communication apparatus performs the communication method in any one of the possible implementations of the first aspect to the fifth aspect.

In a possible implementation solution, the communication apparatus in the eighth aspect may further include a transceiver. The transceiver may be a transceiver circuit or an interface circuit. The transceiver may be used by the communication apparatus in the eighth aspect to communicate with another communication apparatus.

In this application, the communication apparatus in the eighth aspect may be the network device in the first aspect, the satellite in any one of the second aspect, the fourth aspect, or the fifth aspect, the terminal device in the third aspect, a chip (system) or another part or component that may be disposed in the terminal device, the satellite, or the network device, or an apparatus including the terminal device, the satellite, or the network device.

According to a ninth aspect, a communication apparatus is provided, including a processor and a memory. The memory is configured to store a computer program, and when the processor executes the computer program, the communication apparatus is enabled to perform the communication method in any one of the implementations of the first aspect to the fifth aspect.

In a possible implementation solution, the communication apparatus in the ninth aspect may further include a transceiver. The transceiver may be a transceiver circuit or an interface circuit. The transceiver may be used by the communication apparatus in the eighth aspect to communicate with another communication apparatus.

In this application, the communication apparatus in the ninth aspect may be the network device in the first aspect, the satellite in any one of the second aspect, the fourth aspect, or the fifth aspect, the terminal device in the third aspect, a chip (system) or another part or component that may be disposed in the terminal device, the satellite, or the network device, or an apparatus including the terminal device, the satellite, or the network device.

According to a tenth aspect, a communication apparatus is provided, including a processor. The processor is configured to: be coupled to a memory; and after reading a computer program in the memory, perform, based on the computer program, the communication method in any one of the implementations of the first aspect to the fifth aspect.

In a possible implementation solution, the communication apparatus in the tenth aspect may further include a transceiver. The transceiver may be a transceiver circuit or an interface circuit. The transceiver may be used by the communication apparatus in the eighth aspect to communicate with another communication apparatus.

In this application, the communication apparatus in the tenth aspect may be the network device in the first aspect, the satellite in any one of the second aspect, the fourth aspect, or the fifth aspect, the terminal device in the third aspect, a chip (system) or another part or component that may be disposed in the terminal device, the satellite, or the network device, or an apparatus including the terminal device, the satellite, or the network device.

In addition, for technical effects of the communication apparatus in the seventh aspect to the tenth aspect, refer to the technical effects of the communication method in the first aspect to the fifth aspect.

According to an eleventh aspect, a processor is provided. The processor is configured to perform the communication method in any one of the possible implementations of the first aspect to the fifth aspect.

According to a twelfth aspect, a communication system is provided. The communication system includes a first device, a second device, and a first satellite. The first device is configured to perform the communication method in any implementation of the first aspect, the first satellite is configured to perform the communication method in any implementation of the second aspect, and the second device is configured to perform the communication method in any implementation of the third aspect.

According to a thirteenth aspect, a communication system is provided. The communication system includes a second satellite and a third satellite. The second satellite is configured to perform the method in any implementation of the fourth aspect, and the third satellite is configured to perform the method in any implementation of the fifth aspect.

According to a fourteenth aspect, a computer-readable storage medium is provided, including a computer program or instructions. When the computer program or the instructions are run on a computer, the computer is enabled to perform the communication method in any one of the possible implementations of the first aspect to the fifth aspect.

According to a fifteenth aspect, a computer program product is provided, including a computer program or instructions. When the computer program or the instructions are run on a computer, the computer is enabled to perform the communication method in any one of the possible implementations of the first aspect to the fifth aspect.

### BRIEF DESCRIPTION OF DRAWINGS

FIG. 1 is an example diagram of a scenario of cell handover or cell reselection in a communication system of a terrestrial network;

FIG. 2 is an example diagram of correspondences between cells and transmission reception points in different network architectures;

FIG. 3 is an example diagram of a scenario of cell handover or cell reselection in a communication system of a non-terrestrial network;

FIG. 4 is an example diagram of an architecture of a communication system according to an embodiment of this application;

FIG. 5 is an example diagram of a control plane protocol architecture of the communication system shown in FIG. 4;

FIG. 6 is an example diagram of a user plane protocol architecture of the communication system shown in FIG. 4;

FIG. 7 is an example diagram of an architecture of another communication system according to an embodiment of this application;

FIG. 8 is an example diagram of a relationship between coverage areas of a hyper cell and coverage areas of satellites;

FIG. 9 is an example diagram of a protocol architecture of a communication system according to an embodiment of this application;

FIG. 10 is an example schematic flowchart of a communication method according to an embodiment of this application;

FIG. 11 is an example diagram of another protocol architecture according to an embodiment of this application;

FIG. 12 is an example schematic flowchart of another communication method according to an embodiment of this application;

FIG. 13 is an example diagram of coverage areas of cells corresponding to different satellites according to an embodiment of this application;

FIG. 14 is an example diagram of time-frequency resources for sending synchronization signals by different satellites according to an embodiment of this application;

FIG. 15 is an example diagram of still another protocol architecture according to an embodiment of this application;

FIG. 16 is an example schematic flowchart of still another communication method according to an embodiment of this application;

FIG. 17 is an example schematic flowchart of yet another communication method according to an embodiment of this application;

FIG. 18 is an example diagram of yet another protocol architecture according to an embodiment of this application;

FIG. 19 is an example diagram 1 of a structure of a communication apparatus according to an embodiment of this application; and

FIG. 20 is an example diagram 2 of a structure of a communication apparatus according to an embodiment of this application.

### DESCRIPTION OF EMBODIMENTS

The following describes the technical solutions of this application with reference to the accompanying drawings.

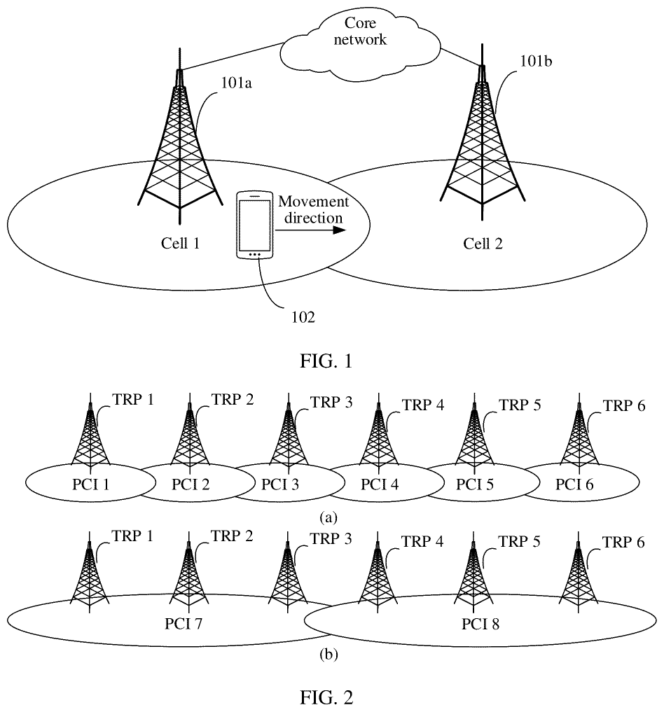

A non-terrestrial network (NTN) may include a satellite network, a high altitude platform, and the like. In particular, the satellite network has significant advantages such as global coverage, long-distance transmission, easy deployment, and being not restricted by geographical conditions. Therefore, the satellite network is widely applied to a plurality of fields such as maritime communication, positioning and navigation, disaster relief, scientific experiments, video broadcasting, and earth observation. The satellite network may be combined with a terrestrial network (a cellular communication network shown in FIG. 1) to provide a wider coverage area, and form an integrated communication network that covers sea, land, air, space, and ground, to provide services for users in different areas.

A next-generation satellite network in the satellite network includes a low earth orbit (LEO) satellite, a medium earth orbit (VEO) satellite, a high earth orbit (HEO) satellite, a geostationary earth orbit (GEO) satellite, a non-geostationary earth orbit (NGEO) satellite, and the like. The next-generation satellite network generally has a trend of being ultra-dense and heterogeneous. A scale of the next-generation satellite network develops from 66 satellites in the Iridium constellation to 720 satellites in the Oneweb constellation, and extends to more than 12,000 satellites in the Starlink ultra-dense low-orbit satellite constellation. In addition, the next-generation satellite network is heterogeneous. With the satellite network evolving from a conventional single-layer communication network to a multi-layer communication network, functions of the satellite network tend to be more complex and diversified, and the satellite network is gradually compatible with and supports functions such as navigation/positioning enhancement, earth observation, and multi-dimensional information on-orbit processing.

In a communication system of the terrestrial network, mobility management such as cell reselection or cell handover is mainly triggered by movement of a terminal device. The following uses an example for description with reference to FIG. 1. The terrestrial network shown in FIG. 1 includes a network device 101a and a network device 101b. The network device 101a provides a network service by using a cell 1, and the network device 101b provides a network service by using a cell 2. If the terminal device moves from the cell 1 to the cell 2 (as shown by a movement direction in FIG. 1), or the terminal device moves from the cell 2 to the cell 1 (not shown in FIG. 1), cell handover or cell reselection occurs. If the terminal device is in the cell 1 or the cell 2 and does not move, cell reselection or cell handover may not be performed. The cell reselection or the cell handover may include: The terminal device initiates a cell reselection or cell handover procedure to a source network device, obtains a physical cell identifier (PCI) or a cell global identifier (CGI) of a target cell from the source network device, accesses the target cell based on the PCI or the CGI of the target cell, and accepts a network service provided by the target cell.

In some embodiments, a hyper cell network architecture may be used in the communication system of the terrestrial network, to reduce frequency of cell handover of the terminal device in a moving process. Anew PCI or GCI needs to be obtained during cell handover or cell reselection. In the hyper cell network architecture, one network device may also be referred to as one transmission reception point (TRP), and cells (e.g., physical cells) corresponding to a plurality of transmission reception points that have contiguous coverage areas and that operate on a same frequency band may be combined into one logical cell. TRPs in one logical cell use a same physical cell identifier (PCI) or cell global identifier (CGI), and the TRPs in the logical cell may be connected to a network device configured to manage the transmission reception points in the hyper cell. In this way, when the terminal device moves in the logical cell, because the PCI or the GCI does not change, cell reselection or cell handover can be avoided, to reduce signaling overheads caused by the cell reselection or cell handover, improve user experience, and reduce a call drop rate caused by a cell reselection or cell handover failure. The following uses a TRP 1 to a TRP 6 as an example to describe the hyper cell network architecture.

As shown in (a) in FIG. 2, in a communication system in which the hyper cell network architecture is not used, PCIs of cells on the TRP 1 to the TRP 6 are sequentially a PCI 1 to a PCI 6. In other words, each transmission reception point corresponds to one cell. When the terminal device moves between coverage areas of any two of the TRP 1 to the TRP 6, cell reselection or cell handover occurs. For example, if the terminal device moves from a cell corresponding to the TRP 1 to a cell corresponding to the TRP 2, or the terminal device moves from the cell corresponding to the TRP 2 to a cell corresponding to the TRP 3, cell reselection or cell handover occurs. As shown in (b) in FIG. 2, in a communication system in which the hyper cell network architecture is used, the physical cells respectively corresponding to the TRP 1 to the TRP 3 shown in (a) in FIG. 2 may be combined into one hyper cell (a hyper cell 1), physical cells corresponding to the TRP 4 and the TRP 5 may be combined into another hyper cell (a hyper cell 2). In this case, the TRP 1 to the TRP 3 all use a same physical cell identifier, for example, a PCI 7, and the TRP 4 to the TRP 6 all use a same physical cell identifier, for example, a PCI 8. In this way, when the terminal device moves between the cell corresponding to the TRP 1 and the cell corresponding to the TRP 2, between the cell corresponding to the TRP 2 and the cell corresponding to the TRP 3, between a cell corresponding to the TRP 4 and a cell corresponding to the TRP 5, or between the cell corresponding to the TRP 5 and a cell corresponding to the TRP 6, a PCI does not change after the movement, and the terminal device cannot sense existence of the plurality of TRPs. Therefore, the terminal device can access a new cell (or referred to as accessing a TRP) without a need of performing layer 3 (L3) switching.

In the hyper cell network architecture, a procedure in which the terminal device accesses a transmission reception point is as follows: The terminal device sends a random access channel preamble (RACH preamble). A TRP that receives the random access channel preamble sends signal quality of the received random access preamble to a network device. The network device may select one from TRPs whose signal quality of a random access preamble is greater than a first signal quality threshold (for example, −6 dB) to provide a service for the terminal device, so that the terminal device accesses the transmission point. In this way, access based on signal quality of a synchronization signal and physical broadcast channel block (SSB) sent by a TRP can be avoided. The signal quality of the random access preamble may be determined based on reference signal received power (RSRP). For example, a TRP with highest RSRP of a random access preamble may be selected to provide a service for the terminal device.

In addition, common information in the hyper cell network architecture, for example, information carried on channels such as a physical downlink control channel (PDCCH), a physical uplink control channel (PUCCH), and a physical random access channel (PRACH), a sounding reference signal (SRS), or an SSB, may be for unified scheduling in the entire logical cell. Terminal device-specific signaling such as radio resource control (RRC) signaling, a medium access control (MAC)-control element (CE), and downlink control information (DCI) may be independently scheduled and allocated by a TRP that provides a network service for the terminal device.

In addition, for TRP switching in a hyper cell, a network device that controls TRPs in the hyper cell may determine, based on quality of an SRS of the terminal device in each TRP, whether to perform TRP switching. For example, the quality of the SRS is determined based on SRS RSRP. If SRS RSRP of a TRP exceeds a first signal quality difference threshold (for example, −110 dBm) of SRS RSRP of a TRP that currently provides a service for the terminal device, the network device may switch to a new TRP that provides a service for the terminal device, so that the terminal device does not sense the TRP switching.

It may be understood that the hyper cell network architecture may be applied to high-speed scenarios such as a high-speed railway, a subway, and a tunnel.

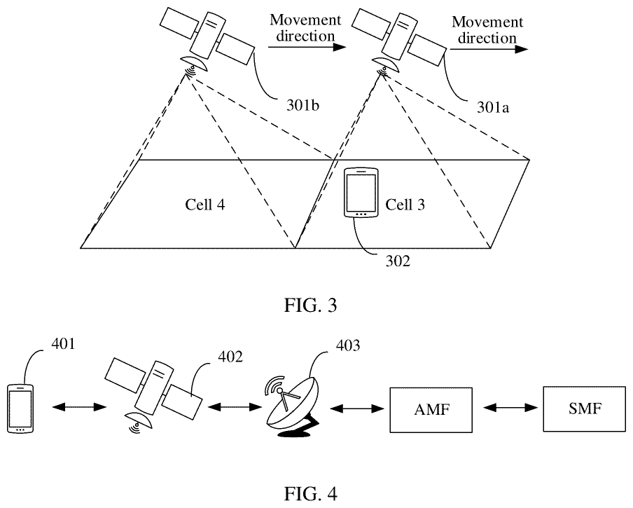

In a communication system of the NTN, mobility management is mainly triggered by high-speed movement of a network device, for example, a satellite. In the NTN, each network device corresponds to one cell. Even if the terminal device does not move, a cell that provides a network service for the terminal device changes due to movement of the network device. In other words, the movement of the network device causes the terminal device to perform cell handover or cell reselection. Each network device may be referred to as a TRP. The following provides descriptions with reference to FIG. 3. As shown in FIG. 3, an example in which the network device in the communication system of the NTN includes a satellite 301a and a satellite 301b is used. The satellite 301a corresponds to a cell 3, the satellite 301b corresponds to a cell 4, and a terminal device 302 is located in the cell 3 and does not move. If the satellite 301a moves in a direction away from the satellite 301b, and a movement direction of the satellite 301b is the same as that of the satellite 301a, a coverage area of the cell 3 moves out of an area in which the terminal device 302 is located, and a coverage area of the cell 4 covers the area in which the terminal device 302 is located. In other words, the terminal device 302 enters the cell 4 from the cell 3. In this case, the terminal device needs to perform cell handover or cell reselection, that is, perform TRP reselection or switching, and re-complete synchronization with the cell to obtain broadcast information of the new cell. In a scenario in which an LEO satellite provides a service, a moving speed of the satellite is about 7.5 kilometers per second, and cell handover or cell reselection is excessively frequent. Frequency of the cell handover or the cell reselection may be calculated in minutes or even seconds.

Therefore, in an NTN network like a satellite network, when a TRP moves at a high speed and the hyper cell network architecture is used, a solution of TRP switching or reselection by using an SRS is not applicable.

In some embodiments, as shown in FIG. 4, the communication system in the non-terrestrial network includes a terminal device 401, a satellite 402, and a terrestrial gateway 403. The terminal device 401 may establish a communication connection to the satellite 402, the satellite 402 may establish a communication connection to the terrestrial gateway 403, and the terrestrial gateway 403 may establish a communication connection to a core network element, for example, an authentication management function (AMF) network element. The AMF network element may establish a communication connection to a session management function (SMF) network element. Alternatively, the terrestrial gateway 403 may establish a communication connection to a core network element, for example, a user plane function (UPF) network element.

The following describes a protocol architecture of the communication system shown in FIG. 4. The terminal device may be connected to the satellite through a Uu interface, and the terrestrial gateway 403 may be connected to the AMF network element through an NG-C interface. The terrestrial gateway 403 may be connected to the UPF network element through an NG-U interface.

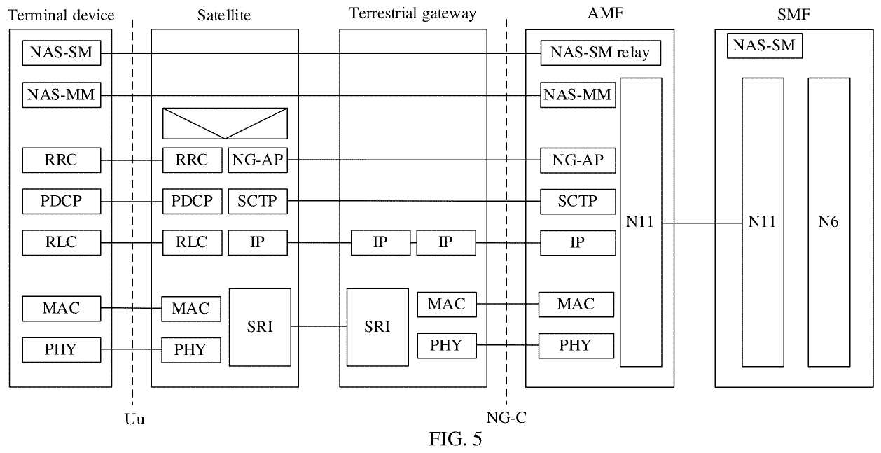

FIG. 5 is a diagram of a control plane (CP) protocol architecture of the communication system shown in FIG. 4. As shown in FIG. 5, in a top-to-bottom order, both the terminal device and the satellite include an RRC entity, a packet data convergence protocol (PDCP) entity, a radio link control (RLC) entity, a MAC, and a physical (PHY) entity. In addition, the terminal device further includes protocol entities located at an upper layer of the RRC entity: a non-access stratum-session management (NAS-SM) entity, and a non-access stratum-mobility management (NAS-MM) entity. The satellite further includes a next generation application protocol (NG-AP) entity, a stream control transmission protocol (SCTP) entity, an internet protocol (IP) entity, and a satellite radio interface (SRI). The terrestrial gateway 403 includes an IP entity and an SRI that correspond to the satellite. In addition, the terrestrial gateway 403 further includes an IP entity, a layer 2 (L2) (for example, a MAC entity), and a layer 1 (L1) (for example, a PHY entity) that correspond to the core network device. The AMF network element includes a NAS-SM relay entity, a NAS-MM entity, an NG-AP entity, an SCTP entity, an IP entity, an L2 (for example, a MAC entity), and an L1 (for example, a PHY entity). In addition, the AMF network element communicates with the SMF network element through an N11 interface, for example, communicates with an N11 interface of the SMF network element. The SMF network element includes a NAS-SM entity, the N11 interface, and an N6 interface. The SMF network element may communicate with a data network (DN) through the N6 interface.

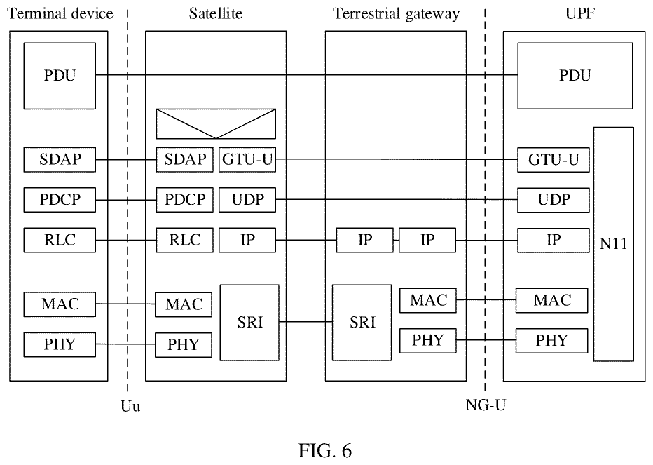

FIG. 6 is a diagram of a user plane (UP) protocol architecture of the communication system shown in FIG. 4. As shown in FIG. 6, in a top-to-bottom order, both the terminal device and the satellite include a service data adaptation protocol (SDAP) entity, a PDCP entity, an RLC entity, a MAC entity, and a PHY entity. In addition, the terminal device further includes protocol entities located at an upper layer of the SDAP entity, for example, a NAS-SM entity and a NAS-MM entity. The satellite further includes an NG-AP entity, a user datagram protocol (UDP) entity, an internet protocol (IP) entity, and an SRI. The terrestrial gateway 403 includes an IP layer and an SRI that correspond to the satellite. In addition, the terrestrial gateway 403 further includes an IP entity, a layer 2 (L2) (for example, a MAC entity), and a layer 1 (L1) (for example, a PHY entity) that correspond to an AMF network element. The AMF network element includes a NAS-SM relay entity, a NAS-MM entity, an NG-AP entity, a UDP entity, an IP entity, an L2 (for example, a MAC entity), and an L1 (for example, a PHY entity). In addition, the AMF network element communicates with the SMF network element through an N11 interface. The SMF network element includes a NAS-SM entity, and the SMF network element may communicate with a data network (DN) through an N6 interface.

It should be noted that FIG. 5 and FIG. 6 are merely examples of diagrams of the protocol architectures provided in embodiments of this application, and the diagram of the protocol architecture may further include another protocol entity. Specifically, protocol entities that have a same name between the core network element and the satellite, between the satellite and the terminal device, between the core network element and the terminal device, between the core network element and the terrestrial gateway 403, and between the terrestrial gateway 403 and the satellite may be referred to as peer protocol entities or corresponding protocol entities. For example, a general packet radio service tunneling protocol (GTP) entity of the core network element of the terminal device and a GTP entity of the satellite are a pair of peer protocol entities, and an SDAP entity of the satellite and an SDAP entity of the terminal device are a pair of peer protocol entities. A peer protocol entity of a transmitter is configured to generate and send data, and a peer protocol entity of a receiver is configured to receive and parse the data sent by the transmitter.

In the communication system shown in FIG. 4, in a process of transmitting information such as data (or referred to as user plane data) or signaling (or referred to as control signaling) from a transmit end to a receive end via the satellite, the satellite needs to perform protocol conversion on the transmitted information. For example, a core network side sends the control signaling to the terminal device by using a control plane protocol stack shown in FIG. 5. After the control signaling is transmitted via the AMF network element to the satellite, the SCTP entity and the NG-AP entity of the satellite sequentially process the control signaling, and the satellite sequentially processes the control signaling by using the RRC entity, the PDCP entity, the RLC entity, the MAC entity, and the PHY entity, and sends processed control signaling to the terminal device. For another example, a core network side sends the user plane data to the terminal device by using a user plane protocol stack shown in FIG. 6. The user plane data is sequentially processed by the protocol data unit (PDU) entity, the SDAP entity, the PDCP entity, the RLC entity, the MAC entity, and the PHY entity, and transmitted to the satellite. The satellite sequentially performs reverse processing by using the PHY entity, the MAC entity, the RLC entity, the PDCP entity, and the SDAP entity, and then performs processing by using the GTU-U entity, the UDP entity, the IP entity, and the SRI, and transmits processed user plane data to the UPF network element through the NTN gateway. That is, when information is transmitted via the satellite, the to-be-transmitted information needs to be decapsulated and re-encapsulated on the satellite. A process of processing the to-be-transmitted information by the satellite is complex and a delay is high, and consequently, communication efficiency the satellite is low. How to improve communication efficiency of the communication system in the hyper cell architecture is an urgent problem to be resolved.

To resolve the technical problem, embodiments of this application provide a communication method. The method may be applied to a communication system including a first device, a satellite, and a second device. The first device and the second device may implement control plane and/or user plane communication via the satellite. Specifically, the method may include: Peer protocol layer entities (or referred to as protocol layers) are disposed in the first device and the second device, first information is obtained by using a protocol entity that is of the first device and that corresponds to the second device, and the first information is forwarded to the second device via the first satellite. In this way, a processing procedure of information in a transmission process is simplified, and communication efficiency is improved.

In addition, in a hyper cell, due to satellite movement, different satellites are needed to provide services for a same sub-area in an area corresponding to the hyper cell. Therefore, how different satellites coordinate to provide services for the hyper cell is an urgent problem to be resolved. Therefore, embodiments of this application provide a communication method. The communication method may be applied to a communication system including a second satellite and a third satellite. The second satellite may obtain third information and send the third information to the third satellite, where the third information is information indicating the third satellite to provide a network service for a terminal device in a first area, and the third information is related to ephemeris information of the third satellite.

The following describes the technical solutions of this application with reference to the accompanying drawings.

The technical solutions of this application may be applied to non-terrestrial network (NTN) systems such as a satellite communication system, a high altitude platform (HAPS) communication system, and an uncrewed aerial vehicle, for example, an integrated communication and navigation (IcaN) system, a global navigation satellite system (GNSS), and an ultra-dense low-orbit satellite communication system. The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system (for example, a new radio (NR) system), or a future mobile communication system.

All aspects, embodiments, or features are presented in this application by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be used.

In addition, in embodiments of this application, the term like “for example” represents giving an example, an illustration, or a description. Any embodiment or implementation solution described as an “example” in this application should not be explained as being more preferred or having more advantages than another embodiment or implementation solution. Exactly, the term “for example” is for presenting a concept in a specific manner.

In the specification and claims of this application, the terms “first”, “second”, and the like are intended to distinguish between similar objects but do not necessarily indicate a specific order or sequence. It should be understood that data used in this way is interchangeable in a proper circumstance, so that embodiments of this application described herein can be implemented in an order other than those illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but may include other steps or units not expressly listed or inherent to the process, method, product, or device.

In embodiments of this application, “at least one” means one or more, and “a plurality of” means two or more. “And/or” describes an association relationship between associated objects, and indicates that at least three relationships may exist. For example, A and/or B may indicate the following cases: Only A exists, both A and B exist, and only B exists, where A and B may be singular or plural. The character “/” generally indicates an “or” relationship between the associated objects. “At least one of the following items (pieces)” or a similar expression thereof means any combination of these items, including a single item (piece) or any combination of a plurality of items (pieces). For example, at least one of a, b, or c may indicate a, b, c, a and b, a and c, b and c, or a, b, and c. a, b, and c may be singular or plural.

In embodiments of this application, sometimes a subscript, for example, W₁, may be written incorrectly in a non-subscript form, for example, W₁. Expressed meanings are consistent when differences are not emphasized.

A network architecture and a service scenario described in embodiments of this application are intended to describe the technical solutions in embodiments of this application more clearly, and do not constitute a limitation on the technical solutions provided in embodiments of this application. A person of ordinary skill in the art may learn that the technical solutions provided in embodiments of this application are also applicable to a similar technical problem as the network architecture evolves and a new service scenario emerges.

For ease of understanding of embodiments of this application, the communication system shown in FIG. 4 is first used as an example to describe in detail a communication system applicable to embodiments of this application. For example, FIG. 4 is a diagram of an architecture of a communication system applicable to a communication method according to an embodiment of this application.

The communication system in this embodiment of this application may include a transparent transmission satellite architecture and a non-transparent transmission satellite architecture. Transparent transmission is also referred to as bent-pipe forwarding transmission. To be specific, only processes such as frequency conversion and signal amplification are performed on a signal on a satellite, and the satellite is transparent to the signal as if the satellite does not exist. Non-transparent transmission may be referred to as regeneration (on-satellite access/processing) transmission. To be specific, the satellite has a part or all of functions of a base station. The satellite mentioned in embodiments of this application may be a satellite base station, may include an orbit receiver or a repeater configured to relay information, or may be a network side device mounted on the satellite. The satellite may be an LEO satellite, an MEO satellite, an HEO satellite, a GEO satellite, an NGEO satellite, or the like. This is not limited in this application.

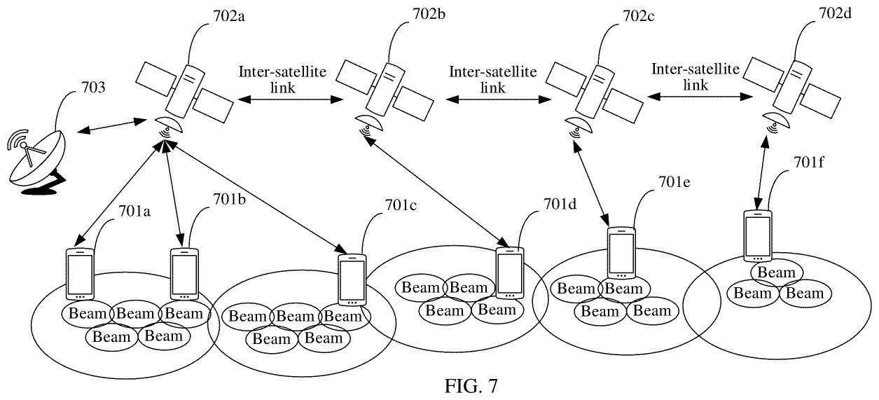

As shown in FIG. 7, the communication system includes at least one terminal device (a terminal device 701a to a terminal device 701e), one or more satellites (a satellite 702a to a satellite 702c), and at least one network device 703.

The plurality of satellites (the satellite 702a to the satellite 702d) each may establish a communication connection to the network device 703, and the terminal devices (the satellite 701a to the satellite 701e) may separately establish a communication connection to each satellite. A communication connection may be established between different satellites.

Each satellite may provide a communication service, a navigation service, or a positioning service for the terminal device over a plurality of beams. One satellite may cover a service area over a plurality of beams, and a service may be provided over different beams through one or more of time division, frequency division, or space division.

In addition, in the communication system shown in FIG. 7, the network device 703 may establish a communication connection to any one of the plurality of satellites (the satellite 701a to the satellite 701e) through an NTN gateway. For example, the network device 703 may establish a communication connection to the NTN gateway, and the NTN gateway may establish a communication connection to the satellite.

At least two satellites in the communication system shown in FIG. 7 provide services for one hyper cell. In other words, the hyper cell may include cells corresponding to at least two satellites in the communication system. When the satellite moves, at different moments, satellites that provide network services for a coverage area of the hyper cell may be the same or may be different. When a satellite moves out of the coverage area of the hyper cell, a satellite that moves into the coverage area of the hyper cell may provide a service for a terminal device in the hyper cell.

Frame numbers of system frames of different cells in a hyper cell may be consecutive (that is, frame synchronization), or may be inconsecutive (in other words, frame synchronization may not be needed). A satellite corresponding to a cell in a hyper cell may include a MAC entity and a PHY entity. In other words, protocol layers of a satellite corresponding to a cell in a hyper cell include a PHY layer and a MAC layer.

The network device may be configured to maintain a context and capability information of the terminal device. The context of the terminal device includes one or more of the following: cell scrambling code of a cell that provides a network service for the terminal device, key information, and resource configuration information. The capability information of the terminal device may include one or more of the following: a power level, whether multi-connectivity is supported, a polarization (for example, circular polarization or linear polarization) capability, or a supported bandwidth. One network device may correspond to one or more hyper cells. In other words, one network device may be configured to manage resource scheduling in the hyper cell. For example, a common channel like a physical broadcast channel (PBCH) or a physical random access channel (PRACH), or common information such as synchronization information (synchronization signal, SS) or paging in a same hyper cell may be scheduled based on the hyper cell. It may be understood that the network device may be further connected to a core network device. The terminal device may store identification information of the terminal device in a current hyper cell. The terminal device may further perform uplink and downlink synchronization with a satellite that provides a service for the terminal device, and store a broadcast message of the hyper cell in which the terminal device is located. The broadcast message may include one or more of the following: a primary system message, a secondary system message, resource configuration information related to random access, an intra-frequency or inter-frequency cell reselection message, or ephemeris information.

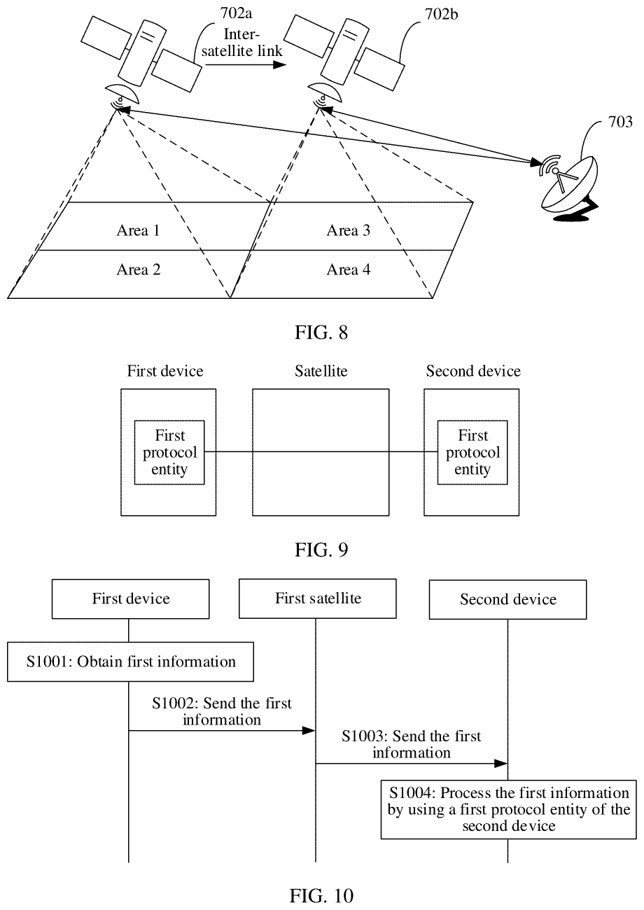

The following further describes a relationship between a hyper cell, a satellite, and a network device by using an example in which one network device 703 corresponds to one hyper cell. As shown in FIG. 8, it is assumed that in a communication system shown in FIG. 8, operating frequency bands of a satellite 702a and a satellite 702b are the same, coverage areas of a cell corresponding to each of the satellite 702a and the satellite 702b are contiguous, and a hyper cell includes an area 1 to an area 7. If in a time period from T0 to T1, a cell corresponding to the satellite 702a covers the area 1 and the area 2, and a cell corresponding to the satellite 702b covers the area 3 and the area 7, in the time period from T0 to T1, the network device 703 may provide a network service for the hyper cell by using the cell corresponding to each of the satellite 702a and the satellite 703b.

It may be understood that different hyper cells may correspond to a same network device. In other words, one network device may be configured to manage a plurality of hyper cells. In addition, the network device may also be referred to as an anchor. For control plane data, the network device may be referred to as a control plane anchor. For user plane data, the network device may be referred to as a user plane anchor. In addition, the control plane anchor and the user plane anchor may be different network devices, or may be a same network device.

The satellite in the communication system shown in FIG. 7 may alternatively be an aircraft, an unmanned aerial system (UAS), an uncrewed aerial vehicle, or the like. A satellite may also be referred to as a TRP.

The network device is a device that is located on a network side of the communication system and that has a wireless transceiver function, or a chip or a chip system that may be disposed in the device. The network device includes but is not limited to an access point (AP) like a home gateway, a router, a server, a switch, or a bridge in a wireless fidelity (Wi-Fi) system, an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), a wireless relay node, a wireless backhaul node, a transmission point (TP), a TRP, and the like; or may be a gNB, a TP, or a TRP in a 5G such as new radio (NR) system, one or a group of antenna panels (including a plurality of antenna panels) of a base station in a 5G system, or a network node, for example, a baseband unit (BBU), a distributed unit (DU), or a road side unit (RSU) having a base station function, that forms a gNB or a transmission reception point. Alternatively, the network device may be a device that undertakes a network side function in a device-to-device (D2D) communication system, a machine to machine (M2M) communication system, an internet of things (IoT), an internet of vehicles communication system, or another communication system.

The terminal device is a terminal that accesses the communication system and that has a wireless transceiver function, or a chip or a chip system that may be disposed in the terminal. The terminal may be a handheld device, a vehicle-mounted device, a wearable device, a computing device, or another processing device connected to a wireless modem. The terminal device may also be referred to as user equipment (UE), an access terminal, a subscriber unit, a subscriber station, a mobile station, a remote station, a remote terminal, a mobile device, a user terminal, a terminal, a wireless communication device, a user agent, or a user apparatus. The terminal device in embodiments of this application may be a mobile phone, a satellite phone, a cellular phone, a smartphone, a wireless data card, a wireless modem, or a machine type communication device, or may be a cordless phone, a session initiation protocol (SIP) phone, a wireless local loop (WLL) station, a personal digital processing (PDA), a wearable device, a tablet computer (Pad), a computer with a wireless transceiver function, a terminal device in virtual reality (VR), a terminal device in augmented reality (AR), a wireless terminal in industrial control, a wireless terminal in self driving, a wireless terminal in telemedicine, a wireless terminal in smart grid, a wireless terminal in transportation security, a wireless terminal in a smart city, a wireless terminal in a smart home, a vehicle-mounted terminal, or a RSU with a terminal function. The terminal device in this application may alternatively be a vehicle-mounted module, a vehicle-mounted assembly, a vehicle-mounted component, a vehicle-mounted chip, or a vehicle-mounted unit that is built in a vehicle as one or more components or units. The vehicle may implement the communication method provided in this application by using the vehicle-mounted module, the vehicle-mounted assembly, the vehicle-mounted component, the vehicle-mounted chip, or the vehicle-mounted unit that is built in the vehicle.

The core network device may be a device in a core network (CN) in an existing mobile communication architecture like a 3rd generation partnership project (3GPP) access architecture of a 5G network, or a device in a core network in a future mobile communication architecture. As a bearer network, the core network provides an interface to a data network, provides communication connection, authentication, management, and policy control for the terminal device, and bearers a data service. The CN may further include network elements such as an access and mobility management function (AMF) network element, a session management function (SMF) network element, an authentication server function (AUSF) network element, a policy control node (PCF), and a user plane function (UPF) network element. The AMF network element is configured to manage access and mobility of the terminal device, and is mainly responsible for functions such as authentication of the terminal device, mobility management of the terminal device, and paging of the terminal device. It should be noted that the communication method provided in embodiments of this application is applicable to the terminal device and the satellite shown in FIG. 4. For a specific implementation, refer to the following method embodiments.

It should be noted that the solutions in embodiments of this application may alternatively be applied to another communication system, and a corresponding name may alternatively be replaced with a name of a corresponding function in the another communication system.

For ease of understanding, in the following method embodiments, a satellite is used as an example for description.

It may be understood that, in some other embodiments, the satellite may alternatively be an aircraft or another mobile device. This is not specifically limited in embodiments of this application.

It should be noted that the communication method provided in embodiments of this application is applicable to the terminal device, the satellite, and the network device shown in FIG. 7. For a specific implementation, refer to the following method embodiments.

It should be noted that the solutions in embodiments of this application may alternatively be applied to another communication system, and a corresponding name may alternatively be replaced with a name of a corresponding function in the another communication system.

It should be understood that FIG. 7 is merely a simplified diagram of an example for ease of understanding. The communication system may further include another network device and/or another terminal device, which is not shown in FIG. 7.

The following specifically describes the communication methods provided in embodiments of this application with reference to FIG. 9 to FIG. 16. The communication methods are applicable to communication between the terminal device, the satellite, and the network device shown in FIG. 7.

For ease of understanding, the following describes a protocol architecture provided in embodiments of this application.

FIG. 9 is a diagram of a protocol architecture according to an embodiment of this application. A first device includes a first protocol entity of the first device, a second device includes a first protocol entity of the second device, and the first protocol entity of the first device corresponds to the first protocol entity of the second device (in other words, the first protocol entity of the first device is equivalent to the first protocol entity of the second device).

It should be noted that a name of the protocol entity is not limited in this application, and the protocol entity may alternatively be named as a protocol layer, a protocol layer entity, or the like. In this application, the protocol entity is used as an example for description. In addition, in this application, that protocol entities of two devices are equivalent may mean that the two devices have protocol layer entities with a same function, for example, with a same function of information decapsulation/encapsulation.

For example, the first device is a transmit end, the second device is a receive end, and the first device sends information (which may be referred to as original information) to the second device via a satellite. The first protocol entity of the first device may be configured to process the original information to obtain first information, the first protocol entity of the second device may be configured to perform inverse processing on the first information to restore the original information. It may be understood that, inversely, when the second device is a transmit end, the first device is a receive end, and the second device sends information to the first device via a satellite, the first protocol entity of the second device may also be configured to process the information (or referred to as original information) generated by the first protocol entity of the second device, to obtain first information, and the first protocol entity of the first device may be configured to perform inverse processing on the first information to restore the original information.

The first device may be the network device in FIG. 7, and the second device may be the terminal device in FIG. 7. Alternatively, the first device may be the terminal device in FIG. 7, and the second device may be the network device in FIG. 7.

For example, FIG. 10 is a schematic flowchart of a communication method according to an embodiment of this application.

As shown in FIG. 10, the communication method includes the following steps.

S1001: A first device obtains first information.

The first information may include service data (or referred to as user plane data), or may include control signaling (or referred to as control data).

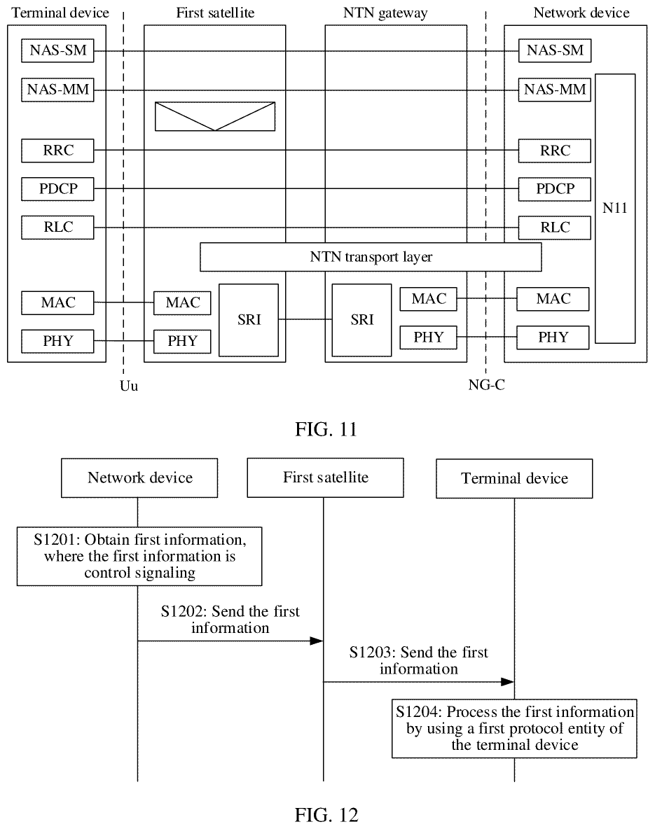

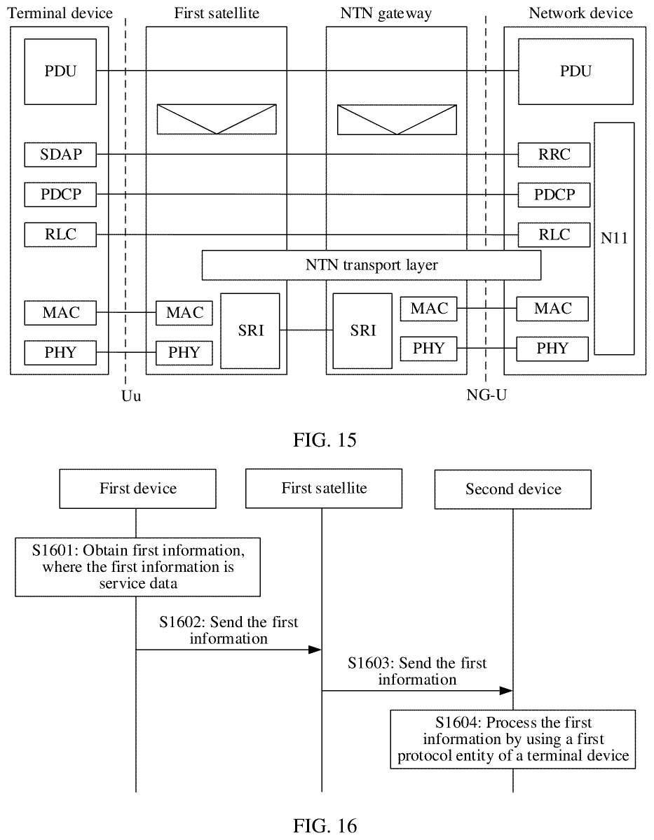

The first information is generated by a first protocol entity of the first device, and the first protocol entity of the first device corresponds to a first protocol entity of a second device. When the first information is the service data, the first protocol entity may be referred to as a user plane protocol entity, for example, may be a control plane protocol entity shown in FIG. 15. When the first information is the control plane signaling, the first protocol entity may be referred to as a control plane protocol entity. For example, the first protocol entity may be a control plane protocol entity shown in FIG. 11.

S1001 may include: The first device processes original information by using the first protocol entity of the first device, to obtain the first information.

For a specific implementation principle of S1001, refer to the following related descriptions of S1201 or S1601.

S1002: The first device sends the first information to a first satellite. Correspondingly, the first satellite receives the first information from the first device.

The first satellite is a satellite that is in a plurality of satellites and that provides a network service for the second device, and the plurality of satellites correspond to one logical cell.

For a specific implementation principle of S1002, refer to the following related descriptions of S1202 or S1602.

S1003: The first satellite sends the first information to the second device. Correspondingly, the second device receives the first information from the first satellite.

For a specific implementation principle of S1003, refer to the following related descriptions of S1203 or S1603.

S1004: The second device processes the first information by using the first protocol entity of the second device.

For a specific implementation principle of S1004, refer to the following related descriptions of S1204 or S1604.

In this way, the first device may generate the first information by using the first protocol entity of the first device, and send the first information to the first satellite, where the first protocol entity of the first device corresponds to the first protocol entity of the second device. In this way, the first protocol entity of the first device and the first protocol entity of the second device may process information, to avoid processing data by the first satellite, so that processing complexity in a data transmission process can be reduced, and communication efficiency can be improved.

For ease of understanding the communication method shown in FIG. 10, the following further describes the communication method with reference to a specific scenario.

In some scenarios, the first device may be a network device, and the second device may be a terminal device; or the first device may be a terminal device, and the second device may be a network device. In addition, the control signaling is transmitted between the network device and the terminal device. In this case, corresponding data is transmitted and processed between the network device, the terminal device, and the first satellite by using a control plane protocol stack. For example, a control plane protocol architecture between the network device, the terminal device, and the first satellite is shown in FIG. 11. The first protocol entity of the network device may include an RRC entity, the first protocol entity of the terminal device also includes an RRC entity, and the RRC entity of the network device corresponds to the RRC entity of the terminal device; and/or the first protocol entity of the network device may include a non-access stratum (NAS) entity, the first protocol entity of the terminal device also includes a NAS entity, and the NAS entity of the network device corresponds to the NAS entity of the terminal device. For a specific function of the RRC entity, refer to the following Table 1. For an implementation principle of the RRC entity, refer to an implementation principle of an existing RRC entity. The NAS entity is for one or more of the following: mobility management, connection control, or session management.

The NAS entity may include a NAS-MM entity and a NAS-SM entity. The NAS-MM entity is for the mobility management and/or the connection control, and the NAS-SM entity is for the session management.

In some possible implementation solutions, the first protocol entity of the network device may include a PDCP entity, and the first protocol entity of the terminal device may also include a PDCP entity. For a specific function of the PDCP entity, refer to the following Table 1. For an implementation principle of the PDCP entity, refer to an implementation principle of an existing PDCP entity.

In some possible implementation solutions, the first protocol entity of the network device may include an RLC entity, and the first protocol entity of the terminal device may also include an RLC entity. For a specific function of the RLC entity, refer to the following Table 1. For an implementation principle of the RLC entity, refer to an implementation principle of an existing RLC entity.

In addition, the network device may further include an N11 interface, a MAC entity, and a PHY entity. The MAC entity may also be referred to as a layer 2 (L2), and the PHY entity may also be referred to as a layer 1 (L1). The terminal device may further include a MAC entity and a PHY entity.

When the first satellite establishes a communication connection to the network device through an NTN gateway, the first satellite may further include an SRI, the NTN gateway may include an SRI, and the SRI of the first satellite corresponds to the SRI of the NTN gateway. The NTN gateway further includes an L2 and an L1, and the L2 and the L1 of the NTN gateway sequentially correspond to the L2 and the L1 of the network device. In addition, an NTN transport layer (TL) is disposed on each of the first satellite, the NTN gateway, and the network device. The NTN TL may use an IP-less transmission protocol, for example, a transmission protocol for transmitting data by using a MAC address, so that L2 transmission of control plane data and user plane data is implemented, in other words, the data does not need to be processed at a higher layer (for example, an IP layer), and signaling overheads and a processing delay are reduced. It may be understood that the entity in this embodiment of this application may be a protocol layer.

In a protocol stack shown in FIG. 11, protocol entities of the terminal device are sequentially a NAS-SM entity, a NAS-MMN entity, an RRC entity, a PDCP entity, an RLC entity, a MAC entity, and a PHY entity from top to bottom. Protocol entities that are of the first satellite and that correspond to the terminal device are sequentially a MAC entity and a PHY entity from top to bottom. In addition, protocol entities that are of the first satellite and that correspond to the NTN gateway are sequentially an NTN TL and an SRI from top to bottom. Protocol entities that are of the NTN gateway and that correspond to the network device include an NTN TL, a MAC entity, and a PHY entity from top to bottom. Protocol entities that are of the NTN gateway and that correspond to the network device include an NTN TL, a MAC entity, and a PHY entity from top to bottom.

Protocol entities of the network device are sequentially a NAS-SM entity, a NAS-MM entity, an RRC entity, a PDCP entity, an RLC entity, an NTN TL, a MAC entity, and a PHY entity from top to bottom.

Functions corresponding to the entities are shown in the following Table 1.

TABLE 1

| Entity | Function |
|---|---|
| NAS-SM | For session management between a second device, a terminal device, |
| | and an SMF network element. |
| NAS-MM | For connection control and mobility management between the second |
| | device, the terminal device, and an AMF network element, and is |
| | transparent to a base station. |
| RRC | For the second device, to be specific, a message between the terminal |
| | device and the base station, including a system message, admission |
| | control, security management, cell reselection, measurement reporting, |
| | handover and mobility, NAS message transmission, radio resource |
| | management, and the like. |
| PDCP | For IP header compression, encryption/decryption (control plane/user |
| | plane), control plane integrity check (there is only a control plane in |
| | 4G, and optional check may be performed on a 5G user plane), |
| | sequencing and replication detection, and a routing function in non- |
| | standalone (NSA) networking. |
| RLC | Transmission mode (TM), also referred to as a transparent mode |
| | (broadcast message), an unacknowledged mode (UM) (voice service, |
| | with a delay requirement), or an acknowledged mode (AM) (common |
| | service, with high accuracy); segmentation and reassembly (for the |
| | UM/AM, where a size of a data packet obtained through segmentation |
| | is determined by a MAC, and the size is large in a good radio |
| | environment and small in a poor radio environment); and error |
| | correction (only for the AM, an automatic repeat request (ARQ), and |
| | high accuracy). |
| MAC | For resource scheduling, mapping between a logical channel and a |
| | transport channel, multiplexing/demultiplexing, a hybrid automatic |
| | repeat request (HARQ), and concatenation/segmentation. |
| PHY | For error detection, forward error correction (FEC), encryption and |
| | decryption, rate matching, physical channel mapping, adjustment and |
| | demodulation, frequency synchronization and time synchronization, |
| | wireless measurement, multiple-input multiple-output (MIMO) |
| | processing, and radio frequency processing. |
| NTN TL | Uses an IP-less transmission protocol to implement fast L2 switching |
| | of control plane and user plane data. |
| SRI | May also be referred to as protocol layers of the SRI (protocol layers |
| | of the SRI), and is configured to implement data transmission between |
| | a satellite and a terrestrial station. |

Based on the protocol architecture shown in FIG. 11, for example, FIG. 12 is a schematic flowchart of another communication method according to an embodiment of this application. The communication method includes the following steps.

S1201: A first device obtains first information.

The first information is control signaling, for example, RRC configuration/reconfiguration signaling and/or NAS signaling.

In some possible implementation solutions, the first information is for performing mobility management and/or access control of the second device, for example, satellite reselection, satellite switching, or registration area update. In other words, the first information is control signaling for performing mobility management and/or access control of the second device.

If the first device includes an RRC entity, the first information may be information generated by the RRC entity of the first device.

In this way, when the terminal device does not move out of a coverage area of the network device, the terminal device does not need to frequently update and reconfigure an RRC message, to reduce signaling overheads and power consumption of the terminal device.

Further, the first information may include one or more of the following: a synchronization signal and physical broadcast channel block SSB-based measurement timing configuration SMTC corresponding to each of a plurality of satellites, a time offset of the SMTC, ephemeris information of a satellite corresponding to a satellite that provides a network service for the second device within a first time length, a first distance threshold for determining whether the second device performs registration area update, time at which the second device performs satellite reselection, time at which the second device performs satellite switching, a location at which the second device performs satellite reselection, a location at which the second device performs satellite switching, and paging configuration information of the second device in the cell corresponding to the plurality of satellites.

In this case, S1201 may include: The first device generates the first information by using the RRC entity of the first device. For example, the first device may process original information by using the RRC entity of the first device, to obtain the first information. For an implementation principle of generating the first information by the first device by using the RRC entity of the first device, refer to a principle of generating information by an RRC entity in a conventional technology.

If the first device includes a NAS entity, the first information may be information generated by the NAS entity of the first device. For an implementation principle of generating the first information by the first device by using the NAS entity of the first device, refer to a principle of generating information by a NAS entity in a conventional technology.

Further, the first information may include registration area update information. The registration area update information indicates whether a registration area of the second device is successfully updated.

In this case, S1201 may include: The first device obtains the first information by using the NAS entity of the first device.

For example, the first device may process original information by using the NAS entity of the first device, to obtain the first information.

For an implementation principle of processing the original information by the first device by using the NAS entity of the first device, to obtain the first information, refer to the conventional technology.

In this way, in a dynamic network (for example, a low-orbit satellite network) environment, when a moving range of the second device is small, cell reselection, cell handover, system message update, registration area update, and other operations may not need to be performed frequently, so that a mobility management procedure of a network is simplified, and signaling overheads for mobility management are reduced.

S1202: The first device sends the first information to a first satellite. Correspondingly, the first satellite receives the first information from the first device.

If the second device is a terminal device, and the first device is a network device, the first information may be carried on a PDSCH. If the first device is a terminal device, and the second device is a network device, the first information may be carried on a PUSCH.

S1203: The first satellite sends the first information to the second device. Correspondingly, the second device receives the first information from the first satellite.

If the second device is the terminal device, and the first device is the network device, the first information may be carried on the PDSCH. If the first device is the terminal device, and the second device is the network device, the first information may be carried on the PUSCH.

S1204: The second device processes the first information by using a first protocol entity of the second device.

If the first information is the information generated by the RRC entity, the second device processes the first information by using an RRC entity. For a specific implementation of processing the first information by the second device by using the RRC entity, refer to the conventional technology.

If the first information is the information generated by the NAS entity, the second device processes the first information by using a NAS entity. For a specific implementation of processing the first information by the second device by using the NAS entity, refer to the conventional technology.

Further, before the first device sends the first information to the first satellite, the method provided in FIG. 12 may further include step 12-1 to step 12-3.

Step 12-1: The second device sends second information to the first satellite. Correspondingly, the first satellite receives the second information from the second device.

The second information indicates to update a location of the second device.

The second information is generated by the second device by using the NAS entity.

Step 12-2: The first satellite sends the second information to the first device. Correspondingly, the first device receives the second information from the first satellite.

Step 12-3: The first device processes the second information by using a first NAS entity.

In this way, the first device can update the location of the second device in a timely manner, to maintain the latest location information of the second device in a timely manner, and improve paging reliability and reduce paging resource overheads.

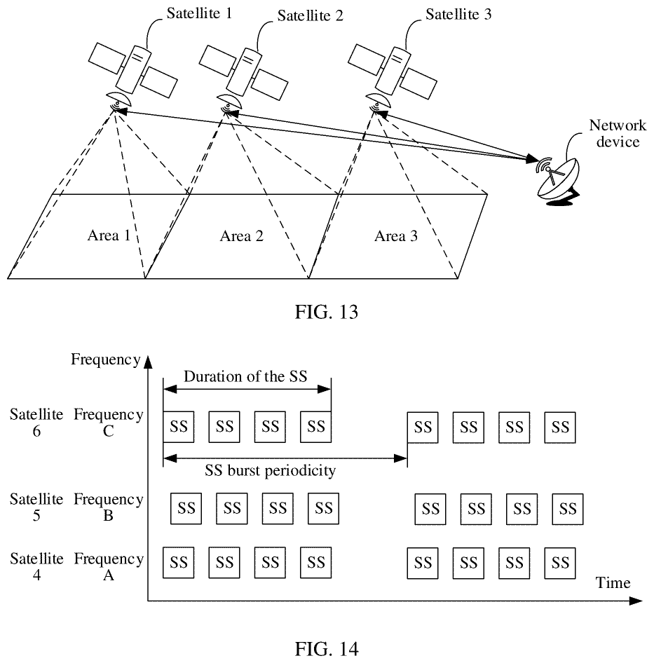

It may be understood that the first information may be broadcast information in a same hyper cell, for example, common channels such as a PBCH and a PRACH, or common information such as SS or paging. Based on this, in the plurality of satellites, a coverage area of a cell corresponding to each satellite is different. As shown in FIG. 13, it is assumed that a hyper cell provides a network service by using a satellite 1 to a satellite 3. In this case, a coverage area of a cell corresponding to the satellite 1 is an area 1, a coverage area of a cell corresponding to the satellite 2 is an area 2, and a coverage area of a cell corresponding to the satellite 3 is an area 3. In addition, the area 1, the area 2, and the area 3 are contiguous and do not overlap. In this case, each satellite sends the first information to a terminal device in an area corresponding to the satellite.

Alternatively, different satellites send the first information on different frequencies. As shown in FIG. 14, for example, a satellite 4 to a satellite 6 respectively send the first information on a frequency A, a frequency B, and a frequency C. For example, the first information is SS. In this case, for each satellite, duration of SS sent by the satellite may occupy a complete SS burst periodicity. In this way, different satellites may send SSs in a same time period, so that access duration of the terminal device can be shortened.

In some scenarios, service data may be transmitted between the first device and the second device. In this case, the first device may be a network device, and the second device may be a terminal device; or the first device may be a terminal device, and the second device may be a network device. In this case, a protocol architecture between the terminal device, the network device, and the first satellite is shown in FIG. 13. The first protocol entity of the terminal device may include an SDAP entity, and the first protocol entity of the second device also includes an SDAP entity; and/or the first protocol entity of the first device may include a PDU entity, and the first protocol entity of the network device also includes a PDU entity. For a function of the SDAP entity, refer to the following Table 2. For an implementation principle of the SDAP entity, refer to an implementation principle of an existing SDAP entity. For a function of the PDU entity, refer to the following Table 2. For an implementation principle of the PDU entity, refer to an implementation principle of an existing PDU entity.

In some possible implementation solutions, the first protocol entity of the network device may include a PDCP entity, and the first protocol entity of the terminal device may also include a PDCP entity.

In some possible implementation solutions, the first protocol entity of the network device may include an RLC entity, and the first protocol entity of the terminal device may also include an RLC entity.

In addition, the network device further includes an N11 interface, a MAC entity, and a PHY entity. The terminal device further includes a MAC layer and a PHY layer.

When the first satellite establishes a communication connection to the network device through an NTN gateway, the first satellite may further include an SRI, the NTN gateway may include an SRI, and the SRI of the first satellite corresponds to the SRI of the NTN gateway. The NTN gateway further includes a MAC entity and a PHY entity, and the MAC entity and the PHY entity of the NTN gateway sequentially correspond to the MAC entity and the PHY entity of the network device. In addition, an NTN transport layer (TL) is disposed on each of the first satellite, the NTN gateway, and the network device, and the NTN TL may use an IP-less transmission protocol, to implement L2 transmission of control plane data and user plane data.

In a protocol stack shown in FIG. 15, protocol entities of the terminal device are sequentially a PDU entity, an SDAP entity, a PDCP entity, an RLC entity, a MAC entity, and a PHY entity from top to bottom. Protocol entities that are of the first satellite and that correspond to the terminal device are sequentially a MAC entity and a PHY entity from top to bottom. In addition, protocol entities that are of the first satellite and that correspond to the NTN gateway are sequentially an NTN TL and an SRI protocol entity from top to bottom. Protocol entities that are of the NTN gateway and that correspond to the network device include an NTN TL, a MAC entity, and a PHY entity from top to bottom. Protocol entities that are of the NTN gateway and that correspond to the network device include an NTN TL, a MAC entity, and a PHY entity from top to bottom.

Protocol entities of the network device are sequentially a PDU entity, an SDAP entity, a PDCP entity, an RLC entity, an NTN TL, a MAC entity, and a PHY entity from top to bottom.

For functions of the PDCP entity, the RLC entity, the MAC entity, the PHY entity, and the SRI protocol entity, refer to the related descriptions in Table 1. Functions of the PDU and the SDAP are shown in the following Table 2.

TABLE 2

| Entity | Function |
|---|---|
| PDU | Data transmitted between a terminal device and a UPF network element, and is |
| | transparent to a base station. |
| SDAP | Responsible for mapping between a quality of service (QoS) flow and a data radio |
| | bearer (DRB), and adding a QoS flow identifier (QFI) marker to a data packet. |

Based on the protocol architecture in FIG. 15, the first device may send service data to the second device. In this case, a communication method is shown in FIG. 16.

For example, FIG. 16 is a schematic flowchart of still another communication method according to an embodiment of this application. The communication method includes the following steps.

S1601: A first device obtains first information.

The first information is service data. In this case, S1501 may include: The first device obtains the first information by using protocol entities from top to bottom. For example, the first device sequentially processes original information by using a PDU entity, an SDAP entity, a PDCP entity, an RLC entity, a MAC entity, and a PHY entity, to obtain the first information.

S1602: The first device sends the first information to a first satellite. Correspondingly, the first satellite receives the first information from the first device.

If the first device is a network device, and the second device is a terminal device, the first information may be carried on a PUSCH. If the second device is a network device and the first device is a terminal device, the first information may be carried on a PDSCH.

S1603: The first satellite sends the first information to a second device. Correspondingly, the second device receives the first information from the first satellite.

If the first device is the terminal device, and the second device is the network device, the first information may be carried on the PUSCH. If the second device is the network device, and the first device is the terminal device, the first information may be carried on the PDSCH.

S1604: The second device processes the first information by using a first protocol entity of the second device.

The second device processes the first information by using protocol entities from bottom to top in the first protocol entity of the second device. For example, the second device sequentially processes the first information by using a PHY entity, a MAC entity, an RLC entity, a PDCP entity, an SDAP entity, and a PDU entity, to obtain the original information.

In FIG. 12 or FIG. 16, for a principle of processing information by each protocol entity, refer to an implementation principle of processing information by each protocol entity in the conventional technology.

In FIG. 10, FIG. 12, or FIG. 16, a field of the first information, for example, a header field, may carry indication information, and the indication information may indicate whether the first satellite processes the first information. When the indication information indicates that the first information processes the first information, the indication information may further indicate a manner in which the first satellite processes the first information, for example, indicate which protocol entities are for processing the first information.

In some other embodiments, when there is an inter-satellite communication link, different satellites may communicate with each other, to perform mobility management of the terminal device.

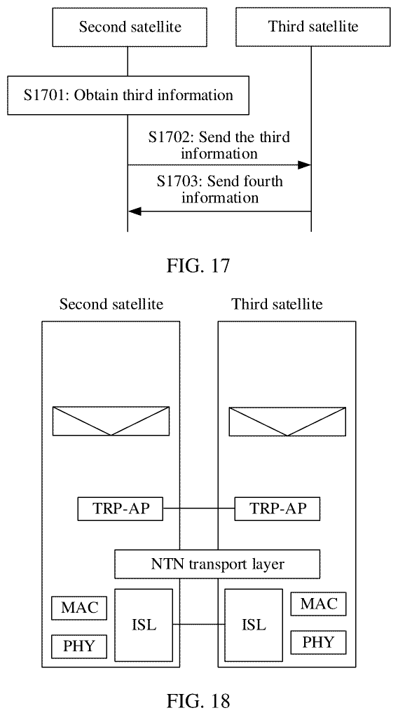

FIG. 17 is a schematic flowchart of yet another communication method according to an embodiment of this application. The communication method includes the following steps.

S1701: A second satellite obtains third information.

The second satellite is a satellite that currently provides a network service for a terminal device in a first area, the third information is information indicating a third satellite to provide a network service for the terminal device in the first area, and the third information is related to ephemeris information of the third satellite.

In a possible implementation solution, the third information may include one or more of the following: routing information used by the third satellite to provide a network service for the first area, identification information of the first area, or a time period in which the second satellite provides a service for the first area. In this way, service time and service areas of different satellites can be coordinated, and interference in a coordinated coverage area is reduced.

In a possible implementation solution, the third information may further include first identification information of the terminal device, a time-frequency resource used by the third satellite to provide the network service for the terminal device, the ephemeris information of the third satellite, measurement configuration information of the third satellite, second identification information of the third satellite, SSB information of the third satellite, a frequency of the third satellite, polarization information of the third satellite, a reference point location of the third satellite, and information for synchronization between the second satellite and the third satellite.

For example, if the second satellite requests the third satellite to provide a network service for a terminal device in an area currently served by the second satellite, in other words, requests for satellite switching, the third information may be a handover request (handover request). In this case, the third information may include one or more of the following: the first identification information of the terminal device, the time-frequency resource used by the third satellite to provide the network service for the terminal device, the ephemeris information of the third satellite, and the measurement configuration information of the third satellite, for example, radio resource measurement (RRM) information.

If the second satellite requests the third satellite to update configuration information, the third information may be a configuration update request. In this case, the third information includes one or more of the following: the second identification information of the third satellite, the SSB information (for example, an SSB pattern) of the third satellite, the frequency of the third satellite, the polarization information of the third satellite, and the reference point location of the third satellite.

If the second satellite requests the third satellite to update routing information, the third information may be a routing update request (e.g., routing request). In this case, the third information includes one or more of the following: information about a route from the third satellite to a destination node, namely, information about a next-hop node from the third satellite to a destination address. For example, if the destination node is a satellite, the routing update information may include a number, an address, and a location of the satellite, a number, an address, and a location of a terrestrial station, or the like.

If the second satellite requests the third satellite to be synchronized with the second satellite, the third information may be a synchronization request. In this case, the third information may include one or more of the following: time (for example, absolute time or a frame boundary of a system frame) between the second satellite and the third satellite, a frequency for providing a network service, a global navigation satellite system (GNSS) location, and the like.

S1702: The second satellite sends the third information to the third satellite. Correspondingly, the third satellite receives the third information from the second satellite.

In a possible implementation solution, the second satellite may communicate with the third satellite through a newly added interface, for example, a transmission reception node interface protocol TRP-AP interface. In this case, that the second satellite sends the third information to the third satellite may include: The second satellite sends the third information to the third satellite through the TRP-AP interface. That the third satellite receives the third information from the second satellite may include: The third satellite receives the third information from the second satellite through the transmission reception node interface protocol TRP-AP interface. In this way, the third information may be transmitted through the new interface, to improve flexibility of information transmission.

A protocol architecture of the TRP-AP interface is shown in FIG. 18. The second satellite may include a TRP-AP interface, and correspondingly, the third satellite also includes a TRP-AP interface.

In addition, the second satellite and the third satellite may further include a protocol entity located at a lower layer of the TRP-AP interface, for example, an inter-satellite link (ISL) protocol entity.

In addition, the second satellite may further include a MAC layer and a PHY layer that correspond to the terminal device, and the third satellite may further include a MAC layer and a PHY layer that correspond to a network device.

S1703: The third satellite sends fourth information to the second satellite. Correspondingly, the second satellite receives the fourth information from the third satellite.

The fourth information indicates a feedback result of the third satellite for the third information.

For example, if the second satellite communicates with the third satellite through the newly added interface, S1703 may include: The third satellite sends the fourth information to the second satellite through the TRP-AP interface. Correspondingly, the second satellite receives the fourth information from the third satellite through the TRP-AP interface.

For example, if the second satellite communicates with the third satellite by reusing an Xn interface, S1703 may include: The third satellite sends the fourth information to the second satellite through the Xn interface. Correspondingly, the second satellite receives the fourth information from the third satellite through the Xn interface.

For example, a correspondence between the third information and the fourth information is shown in the following Table 3. If the third information is the handover request, the fourth information is a handover acknowledge message indicating that satellite switching succeeds, or a handover failure message indicating that the satellite switching fails. If the third information is the configuration update request, the fourth information is a configuration update acknowledge (e.g., configuration acknowledge) message indicating that configuration update succeeds, or a configuration update failure (e.g., configuration failure) message indicating that the configuration update fails. If the third information is the routing update information, the fourth information is a routing acknowledge message indicating that routing update succeeds, or a routing failure message indicating that the routing update fails. If the third information is a synchronization request, the fourth information is a synchronization acknowledge message indicating that synchronization succeeds, or a synchronization failure message indicating that the synchronization fails.

TABLE 3

| Third information | Fourth information | |
|---|---|---|
| Handover request | Handover acknowledge message | Handover failure message |
| Configuration update | Configuration update | Configuration update failure |
| request | acknowledge message | message |
| Routing request | Routing acknowledge message | Routing failure message |
| Synchronization request | Synchronization acknowledge | Synchronization failure |
| | message | message |

In a possible implementation solution, the second satellite may communicate with the third satellite by reusing an existing interface, for example, the Xn interface or an X2 interface. The Xn interface is used as an example. In this case, that the second satellite sends the third information to the third satellite may include: The second satellite sends the third information to the third satellite through the Xn interface. That the third satellite receives the third information from the second satellite may include: The third satellite receives the third information from the second satellite through the Xn interface. The communication method shown in FIG. 17 may be applied to a hyper cell scenario. In this case, the second satellite or the third satellite may include a first protocol entity of the foregoing first satellite. For example, first protocol entities corresponding to the terminal device include a MAC entity and a PHY entity from top to bottom. In addition, the second satellite or the third satellite may be connected to the first device and/or the second device in the communication method shown in FIG. 10.

In this way, information transmission can be performed between the second satellite and the third satellite by reusing the existing interface, so that development costs of a new interface can be reduced.

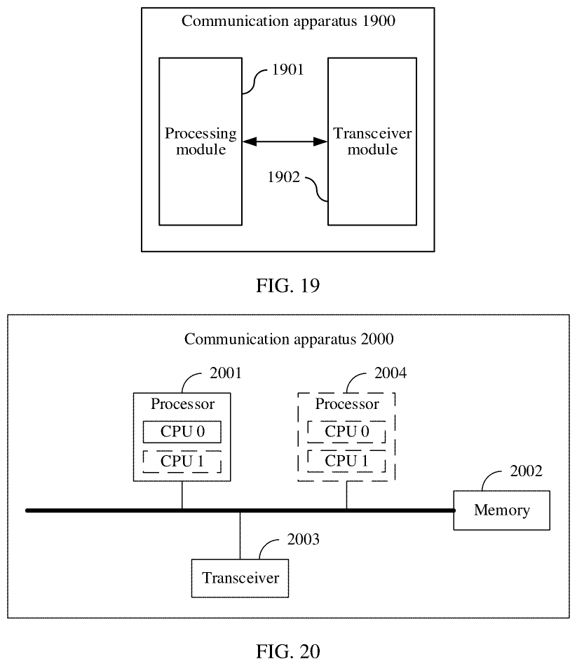

The foregoing describes in detail the communication methods provided in embodiments of this application with reference to FIG. 9 to FIG. 18. The following describes in detail communication apparatuses configured to perform the communication methods provided in embodiments of this application with reference to FIG. 19 and FIG. 20.

For example, FIG. 19 is a diagram 1 of a structure of a communication apparatus according to an embodiment of this application. As shown in FIG. 19, the communication apparatus 1900 includes a processing module 1901 and a transceiver module 1902. For ease of description, FIG. 19 shows only main components of the communication apparatus 1900.

In some embodiments, the communication apparatus 1900 is applicable to the communication system shown in FIG. 7, and performs a function of the first device in the communication method shown in FIG. 10, FIG. 12, or FIG. 16.

The processing module 1901 is configured to obtain first information.

The first information is generated by a first protocol entity of the processing module 1901, and the first protocol entity of the processing module 1901 corresponds to a first protocol entity of a second device.

The transceiver module 1902 is configured to send the first information to a first satellite.

The first satellite is a satellite that is in a plurality of satellites and that provides a network service for the second device, and the plurality of satellites correspond to one logical cell.

In a possible implementation solution, the first information may be for performing mobility management of the second device.

Optionally, the first protocol entity of the processing module 1901 may include a radio resource control RRC entity. The first information is generated by the RRC entity.

In a possible implementation solution, the first information may include one or more of the following: a synchronization signal and physical broadcast channel block SSB-based measurement timing configuration SMTC corresponding to each of the plurality of satellites, a time offset of the SMTC, ephemeris information of a satellite corresponding to a satellite that provides a network service for the second device within a first time length, a first distance threshold for determining whether the second device performs registration area update, time at which the second device performs satellite reselection, time at which the second device performs satellite switching, a location at which the second device performs satellite reselection, a location at which the second device performs satellite switching, and paging configuration information of the second device in the cell corresponding to the plurality of satellites.

Optionally, the first protocol entity of the processing module 1901 may include a non-access stratum NAS entity. The first information is generated by the NAS entity.

Further, the first information may include registration area update information. The registration area update information indicates whether a registration area of the second device is successfully updated.

Further, the transceiver module 1902 is further configured to receive second information from the first satellite.

The processing module 1901 is further configured to process the second information by using the NAS entity. The second information indicates to update a location of the second device.

In a possible implementation solution, the first protocol entity of the processing module 1901 may include a service data adaptation protocol SDAP entity.

In a possible implementation solution, the first protocol entity of the processing module 1901 may further include a packet data convergence protocol PDCP entity.

In a possible implementation solution, the first protocol entity of the processing module 1901 may further include a radio link control RLC entity.

In a possible implementation solution, coverage areas of the cells corresponding to the plurality of satellites are different. Alternatively, frequencies respectively used by the plurality of satellites to send SSBs are different.

Optionally, the transceiver module 1902 may include a receiving module and a sending module (not shown in FIG. 19). The transceiver module 1902 is configured to implement a sending function and a receiving function of the communication apparatus 1900.

Optionally, the communication apparatus 1900 may further include a storage module (not shown in FIG. 19). The storage module stores a program or instructions. When the processing module 1901 executes the program or the instructions, the communication apparatus 1900 is enabled to perform the function of the first device in the communication method shown in any one of FIG. 10, FIG. 12, or FIG. 16.

It should be understood that the processing module 1901 in the communication apparatus 1900 may be implemented by a processor or a processor-related circuit component, and may be a processor or a processing unit. The transceiver module 1902 may be implemented by a transceiver or a transceiver-related circuit component, and may be a transceiver or a transceiver unit.

It should be noted that the communication apparatus 1900 may be a terminal device or a network device, may be a chip (system) or another part or component that may be disposed in the terminal device or the network device, or may be an apparatus including the terminal device or the network device. This is not limited in this application.

In addition, for technical effects of the communication apparatus 1900, refer to the technical effects of the communication method shown in any one of FIG. 10, FIG. 12, or FIG. 16.

In some other embodiments, the communication apparatus 1900 is applicable to the communication system shown in FIG. 7, and performs a function of the first satellite in the communication method shown in FIG. 10, FIG. 12, or FIG. 16.

The processing module 1901 is configured to receive first information from a first device via the transceiver module 1902.

The communication apparatus 1900 is a communication apparatus that is in a plurality of communication apparatuses and that provides a network service for a second device, and the plurality of communication apparatuses correspond to one logical cell.

The processing module 1901 is further configured to send the first information to the second device via the transceiver module 1902.

In a possible implementation solution, the first information may be for performing mobility management of the second device.

In a possible implementation solution, the first information may include one or more of the following: a synchronization signal and physical broadcast channel block SSB-based measurement timing configuration SMTC corresponding to each of the plurality of communication apparatuses, a time offset of the SMTC, ephemeris information of a communication apparatus corresponding to a cell that provides a network service for the second device within a first time length, a first distance threshold for determining whether the second device performs registration area update, time at which the second device performs communication apparatus reselection, time at which the second device performs communication apparatus switching, a location at which the second device performs communication apparatus reselection, a location at which the second device performs communication apparatus switching, and paging configuration information of the second device in the cell corresponding to the plurality of communication apparatuses.

In a possible implementation solution, the first information may include registration area update information. The registration area update information indicates whether a registration area of the second device is successfully updated.

Further, the processing module 1901 is further configured to send second information to the first device via the transceiver module 1902.

The second information indicates to update a location of the second device.

In a possible implementation solution, coverage areas of cells corresponding to the plurality of communication apparatuses are different. Alternatively, frequencies respectively used by the plurality of communication apparatuses to send SSBs are different.

Optionally, the transceiver module 1902 may include a receiving module and a sending module (not shown in FIG. 19). The transceiver module 1902 is configured to implement a sending function and a receiving function of the communication apparatus 1900.

Optionally, the communication apparatus 1900 may further include a storage module (not shown in FIG. 19). The storage module stores a program or instructions. When the processing module 1901 executes the program or the instructions, the communication apparatus 1900 is enabled to perform the function of the first satellite in the communication method shown in any one of FIG. 10, FIG. 12, or FIG. 16.

It should be understood that the processing module 1901 in the communication apparatus 1900 may be implemented by a processor or a processor-related circuit component, and may be a processor or a processing unit. The transceiver module 1902 may be implemented by a transceiver or a transceiver-related circuit component, and may be a transceiver or a transceiver unit.

It should be noted that the communication apparatus 1900 may be a terminal device or a network device, may be a chip (system) or another part or component that may be disposed in the terminal device or the network device, or may be an apparatus including the terminal device or the network device. This is not limited in this application.

In addition, for technical effects of the communication apparatus 1900, refer to the technical effects of the communication method shown in any one of FIG. 10, FIG. 12, or FIG. 16.

In still some embodiments, the communication apparatus 1900 is applicable to the communication system shown in FIG. 7, and performs a function of the second device in the communication method shown in any one of FIG. 10, FIG. 12, or FIG. 16.

The transceiver module 1902 is configured to receive first information from a first satellite.

The first satellite is a satellite that is in a plurality of satellites and that provides a network service for the communication apparatus 1900, and the plurality of satellites correspond to one logical cell.

The processing module 1901 is configured to process the first information by using a first protocol entity of the processing module 1901.

The first protocol entity of the processing module 1901 corresponds to a first protocol entity of a first device.

In a possible implementation solution, the first information is for performing mobility management of the communication apparatus 1900.

In a possible implementation solution, the first protocol entity of the processing module 1901 may include a radio resource control protocol RRC entity, and the processing module 1901 is specifically configured to process the first information by using the RRC entity.

Further, the first information may include: a synchronization signal and physical broadcast channel block SSB-based measurement timing configuration SMTC corresponding to each of the plurality of satellites, a time offset of the SMTC, ephemeris information of a satellite corresponding to a cell that provides a network service for the communication apparatus 1900 within a first time length, a first distance threshold for determining whether the communication apparatus 1900 performs registration area update, time at which the communication apparatus 1900 performs satellite reselection, time at which the communication apparatus 1900 performs satellite switching, a location at which the communication apparatus 1900 performs satellite reselection, a location at which the communication apparatus 1900 performs satellite switching, and paging configuration information of the communication apparatus 1900 in the cell corresponding to the plurality of satellites.

In a possible implementation solution, the first protocol entity of the processing module 1901 may include a non-access stratum NAS entity. The processing module 1901 is specifically configured to process the first information by using the NAS entity.

Further, the first information may include registration area update information. The registration area update information indicates whether a registration area of the communication apparatus 1900 is successfully updated.

Further, the transceiver module 1902 may be further configured to send second information to the first satellite.

The second information indicates to update a location of the communication apparatus 1900.

In a possible implementation solution, the processing module 1901 is further configured to perform mobility management based on the first information.

In a possible implementation solution, the first protocol entity of the processing module 1901 may include a service data adaptation protocol SDAP entity.

In a possible implementation solution, the first protocol entity of the processing module 1901 may further include a packet data convergence protocol PDCP entity.

In a possible implementation solution, the first protocol entity of the processing module 1901 may further include a radio link control RLC entity.

In a possible implementation solution, coverage areas of the cells corresponding to the plurality of satellites are different. Alternatively, frequencies respectively used by the plurality of satellites to send SSBs are different.

Optionally, the transceiver module 1902 may include a receiving module and a sending module (not shown in FIG. 19). The transceiver module 1902 is configured to implement a sending function and a receiving function of the communication apparatus 1900.

Optionally, the communication apparatus 1900 may further include a storage module (not shown in FIG. 19). The storage module stores a program or instructions. When the processing module 1901 executes the program or the instructions, the communication apparatus 1900 is enabled to perform the function of the second device in the communication method shown in any one of FIG. 10, FIG. 12, or FIG. 16.

It should be understood that the processing module 1901 in the communication apparatus 1900 may be implemented by a processor or a processor-related circuit component, and may be a processor or a processing unit. The transceiver module 1902 may be implemented by a transceiver or a transceiver-related circuit component, and may be a transceiver or a transceiver unit.

It should be noted that the communication apparatus 1900 may be a terminal device or a network device, may be a chip (system) or another part or component that may be disposed in the terminal device or the network device, or may be an apparatus including the terminal device or the network device. This is not limited in this application.

In addition, for technical effects of the communication apparatus 1900, refer to the technical effects of the communication method shown in any one of FIG. 10, FIG. 12, or FIG. 16.

In yet some embodiments, the communication apparatus 1900 is applicable to the communication system shown in FIG. 7, and performs a function of the second satellite in the communication method shown in FIG. 17.

The processing module 1901 is configured to obtain third information.

The communication apparatus 1900 is a communication apparatus that currently provides a network service for a terminal device in a first area, the third information is information indicating a third satellite to provide a network service for the terminal device in the first area, and the third information is related to ephemeris information of the third satellite.

The transceiver module 1902 is configured to send the third information to the third satellite.

In a possible implementation solution, the third information may include one or more of the following: routing information used by the third satellite to provide a network service for the first area, identification information of the first area, or a time period in which the communication apparatus 1900 provides a service for the first area.

In a possible implementation solution, the transceiver module 1902 is specifically configured to send the third information to the third satellite through a transmission reception node interface protocol TRP-AP interface.

Optionally, the transceiver module 1902 is further configured to receive fourth information from the third satellite through the TRP-AP interface. The fourth information indicates a feedback result of the third satellite for the third information.

In a possible implementation solution, the transceiver module 1902 is specifically configured to send the third information to the third satellite through an Xn interface.

In a possible implementation solution, the third information may further include: first identification information of the terminal device, a time-frequency resource used by the third satellite to provide the network service for the terminal device, the ephemeris information of the third satellite, measurement configuration information of the third satellite, second identification information of the third satellite, SSB information of the third satellite, a frequency of the third satellite, polarization information of the third satellite, a reference point location of the third satellite, and information for synchronization between the communication apparatus 1900 and the third satellite.

Optionally, the transceiver module 1902 may include a receiving module and a sending module (not shown in FIG. 19). The transceiver module 1902 is configured to implement a sending function and a receiving function of the communication apparatus 1900.

Optionally, the communication apparatus 1900 may further include a storage module (not shown in FIG. 19). The storage module stores a program or instructions. When the processing module 1901 executes the program or the instructions, the communication apparatus 1900 is enabled to perform the function of the second satellite in the communication method shown in FIG. 17.

It should be understood that the processing module 1901 in the communication apparatus 1900 may be implemented by a processor or a processor-related circuit component, and may be a processor or a processing unit. The transceiver module 1902 may be implemented by a transceiver or a transceiver-related circuit component, and may be a transceiver or a transceiver unit.

It should be noted that the communication apparatus 1900 may be a terminal device or a network device, may be a chip (system) or another part or component that may be disposed in the terminal device or the network device, or may be an apparatus including the terminal device or the network device. This is not limited in this application.

In addition, for technical effects of the communication apparatus 1900, refer to the technical effects of the communication method shown in FIG. 17.

In still yet some embodiments, the communication apparatus 1900 is applicable to the communication system shown in FIG. 7, and performs a function of the third satellite in the communication method shown in FIG. 17.

The processing module 1901 is configured to receive third information from a second satellite via the transceiver module 1902.

The second satellite is a satellite that currently provides a network service for a terminal device in a first area. The third information is information indicating the communication apparatus 1900 to provide a network service for the terminal device in the first area, and the third information is related to ephemeris information corresponding to the communication apparatus 1900.

The processing module 1901 is configured to send fourth information to the second satellite via the transceiver module 1902. The fourth information indicates a feedback result of the communication apparatus 1900 for the third information.

In a possible implementation solution, the third information may include one or more of the following: routing information used by the communication apparatus 1900 to provide a network service for the first area, identification information of the first area, or a time period in which the second satellite provides a service for the first area.

In a possible implementation solution, the processing module 1901 is specifically configured to receive the third information from the second satellite through a transmission reception node interface protocol TRP-AP interface of the transceiver module 1902.

Optionally, the processing module 1901 is specifically configured to send the fourth information to the second satellite through the TRP-AP interface of the transceiver module 1902.

In a possible implementation solution, the processing module is specifically configured to receive the third information from the second satellite through an Xn interface of the transceiver module.

In a possible implementation solution, the third information may further include: first identification information of the terminal device, a time-frequency resource used by the communication apparatus 1900 to provide the network service for the terminal device, the ephemeris information of the communication apparatus 1900, measurement configuration information of the communication apparatus 1900, second identification information of the communication apparatus 1900, SSB information of the communication apparatus 1900, a frequency of the communication apparatus 1900, polarization information of the communication apparatus 1900, a reference point location of the communication apparatus 1900, and information for synchronization between the second satellite and the communication apparatus 1900.

Optionally, the communication apparatus 1900 may further include a storage module (not shown in FIG. 19). The storage module stores a program or instructions. When the processing module 1901 executes the program or the instructions, the communication apparatus 1900 is enabled to perform the function of the third satellite in the communication method shown in FIG. 17.

It should be understood that the processing module 1901 in the communication apparatus 1900 may be implemented by a processor or a processor-related circuit component, and may be a processor or a processing unit. The transceiver module 1902 may be implemented by a transceiver or a transceiver-related circuit component, and may be a transceiver or a transceiver unit.

It should be noted that the communication apparatus 1900 may be a terminal device or a network device, may be a chip (system) or another part or component that may be disposed in the terminal device or the network device, or may be an apparatus including the terminal device or the network device. This is not limited in this application.

In addition, for technical effects of the communication apparatus 1900, refer to the technical effects of the communication method shown in FIG. 17.

For example, FIG. 20 is a diagram 2 of a structure of a communication apparatus according to an embodiment of this application. The communication apparatus may be a terminal device or a network device, or may be a chip (system) or another part or component that may be disposed in the terminal device or the network device. As shown in FIG. 20, the communication apparatus 2000 may include a processor 2001. Optionally, the communication apparatus 2000 may further include a memory 2002 and/or a transceiver 2003. The processor 2001 is coupled to the memory 2002 and the transceiver 2003, for example, may be connected through a communication bus.

The following describes each part in the communication apparatus 2000 in detail with reference to FIG. 20.

The processor 2001 is a control center of the communication apparatus 2000, and may be one processor, or may be a general term of a plurality of processing elements. For example, the processor 2001 is one or more central processing units (CPUs), or may be an application-specific integrated circuit (ASIC) or one or more integrated circuits configured to implement embodiments of this application, for example, one or more digital signal processors (DSPs), or one or more field programmable gate arrays (FPGAs).

Optionally, the processor 2001 may perform various functions of the communication apparatus 2000 by running or executing a software program stored in the memory 2002 and invoking data stored in the memory 2002.

During specific implementation, in an embodiment, the processor 2001 may include one or more CPUs, for example, a CPU 0 and a CPU 1 shown in FIG. 20.

During specific implementation, in an embodiment, the communication apparatus 2000 may further include a plurality of processors, for example, the processor 2001 and a processor 2004 shown in FIG. 20. Each of the processors may be a single-core processor (e.g., single-CPU), or may be a multi-core processor (e.g., multi-CPU). The processor herein may be one or more devices, circuits, and/or processing cores configured to process data (for example, computer program instructions).

The memory 2002 is configured to store a software program for performing the solutions of this application, and the processor 2001 controls execution of the software program. For a specific implementation, refer to the foregoing method embodiments.

Optionally, the memory 2002 may be a read-only memory (ROM) or another type of static storage device capable of storing static information and instructions, or a random access memory (RAM) or another type of dynamic storage device capable of storing information and instructions, or may be an electrically erasable programmable read-only memory (EEPROM), a compact disc read-only memory (CD-ROM) or other compact disc storage, optical disc storage (including a compressed optical disc, a laser disc, an optical disc, a digital versatile disc, a Blu-ray disc, or the like), a magnetic disk storage medium or another magnetic storage device, or any other medium capable of carrying or storing expected program code in a form of an instruction or a data structure and capable of being accessed by a computer, but is not limited thereto. The memory 2002 may be integrated with the processor 2001, or may exist independently and is coupled to the processor 2001 through an interface circuit (not shown in FIG. 20) of the communication apparatus 2000. This is not specifically limited in embodiments of this application.

The transceiver 2003 is configured to communicate with another communication apparatus. For example, the communication apparatus 2000 is the terminal device, and the transceiver 2003 may be configured to communicate with a network device or communicate with another terminal device. For another example, the communication apparatus 2000 is the network device, and the transceiver 2003 may be configured to communicate with a terminal device or communicate with another network device.

Optionally, the transceiver 2003 may include a receiver and a transmitter (not separately shown in FIG. 20). The receiver is configured to implement a receiving function, and the transmitter is configured to implement a sending function.

Optionally, the transceiver 2003 may be integrated with the processor 2001, or may exist independently and is coupled to the processor 2001 through an interface circuit (not shown in FIG. 20) of the communication apparatus 2000. This is not specifically limited in embodiments of this application.

It should be noted that a structure of the communication apparatus 2000 shown in FIG. 20 does not constitute a limitation on the communication apparatus. An actual communication apparatus may include more or fewer components than those shown in the figure, or combine some components, or have different component arrangements.

In addition, for technical effects of the communication apparatus 2000, refer to the technical effects of the communication method in the foregoing method embodiments.

It should be understood that, the processor in embodiments of this application may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be understood that the memory in embodiments of this application may be a volatile memory or a nonvolatile memory, or may include both the volatile memory and the nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through an example rather than a limitative description, random access memories (RAM) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or a part of the foregoing embodiments may be implemented by software, hardware (for example, circuit), firmware, or any combination thereof. When software is for implementing the embodiments, all or a part of the embodiments may be implemented in a form of a computer program product. The computer program product includes one or more computer instructions or computer programs. When the computer instructions or the computer programs are loaded or executed on a computer, all or a part of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by the computer, or a data storage device like a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid state drive.

It should be understood that the term “and/or” in this specification describes only an association relationship between associated objects, and indicates that at least three relationships may exist. For example, A and/or B may indicate the following three cases: Only A exists, both A and B exist, and only B exists, where A and B may be singular or plural. In addition, the character “/” in this specification usually represents an “or” relationship between the associated objects, but may also represent an “and/or” relationship. For details, refer to the context for understanding.

In this application, “at least one” means one or more, and “a plurality of” means two or more. “At least one of the following items (pieces)” or a similar expression thereof means any combination of these items, including a single item (piece) or any combination of a plurality of items (pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that the units and algorithm steps in the examples described with reference to embodiments disclosed in this specification may be implemented by electronic hardware or a combination of computer software and electronic hardware. Whether these functions are performed by hardware or software depends on particular applications and implementation constraint conditions of the technical solutions. A person skilled in the art may use different methods to implement the described functions for each specific application. However, it should not be considered that this implementation goes beyond the scope of this application.

It may be understood by a person skilled in the art that, for the purpose of convenient and brief description, for specific working processes of the foregoing systems, apparatuses, and units, refer to corresponding processes in the foregoing method embodiments.

In several embodiments provided in this application, it should be understood that the disclosed systems, apparatuses, and methods may be implemented in other manners. For example, the described apparatus embodiments are merely examples. For example, division into the units is merely logical function division. During actual implementation, another division manner may be used. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic, a mechanical, or another form.

The units described as separate parts may or may not be physically separate, and parts displayed as units may or may not be physical units, in other words, may be located in one position, or may be distributed on a plurality of network units. A part or all of the units may be selected based on an actual requirement to achieve objectives of the solutions in the embodiments.

In addition, functional units in embodiments of this application may be integrated into one processing unit, or each unit may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or a part of the technical solutions may be implemented in a form of a software product. The computer software product is stored in a storage medium, and includes several instructions for instructing a computer device (which may be a personal computer, a server, or a network device) to perform all or a part of the steps of the methods described in embodiments of this application. The storage medium includes media such as a USB flash drive, a removable hard disk, a read-only memory (ROM), a random access memory (RAM), a magnetic disk, an optical disc, or the like, that can store program code.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
obtaining, by a first device, first information generated by a first protocol entity of the first device, wherein the first protocol entity of the first device corresponds to a first protocol entity of a second device; and
sending, by the first device, the first information to a first satellite, wherein the first satellite is included in a plurality of satellites and the first satellite provides a network service for the second device, and the plurality of satellites correspond to one logical cell.

2. The method according to claim 1, wherein the first information is used for performing mobility management of the second device.

3. The method according to claim 2, wherein the first protocol entity of the first device comprises a radio resource control (RRC) entity.

4. The method according to claim 1, wherein the first information comprises one or more of: a synchronization signal and physical broadcast channel block (SSB)-based measurement timing configuration (SMTC) corresponding to each of the plurality of satellites, a time offset of the SMTC, ephemeris information of a satellite corresponding to a satellite providing a network service for the second device in a first time length, a first distance threshold for determining whether the second device performs registration area update, time at which the second device performs satellite reselection, time at which the second device performs satellite switching, a location at which the second device performs satellite reselection, a location at which the second device performs satellite switching, or paging configuration information of the second device in the cell corresponding to the plurality of satellites.

5. The method according to claim 2, wherein the first protocol entity of the first device comprises a non-access stratum (NAS) entity.

6. The method according to claim 5, wherein the first information comprises registration area update information indicating whether a registration area of the second device is successfully updated.

7. The method according to claim 5, wherein before sending, by the first device, the first information to a first satellite, the method further comprises:
receiving, by the first device, second information from the first satellite, wherein the second information indicates to update a location of the second device; and
processing, by the first device, the second information by using the NAS entity.

8. The method according to claim 1, wherein the first protocol entity of the first device comprises a service data adaptation protocol (SDAP) entity.

9. The method according to claim 1, wherein the first protocol entity of the first device further comprises a packet data convergence protocol (PDCP) entity.

10. The method according to claim 1, wherein the first protocol entity of the first device further comprises a radio link control (RLC) entity.

11. A communication apparatus, comprising:
a processor operatively coupled to a memory, wherein
the processor is configured to execute a computer program stored in the memory that causes the communication apparatus to:
obtain, by a first device, first information generated by a first protocol entity of the first device, wherein the first protocol entity of the first device corresponds to a first protocol entity of a second device; and
send, by the first device, the first information to a first satellite, wherein the first satellite is included in a plurality of satellites and the first satellite provides a network service for the second device, and the plurality of satellites correspond to one logical cell.

12. The apparatus according to claim 11, wherein the first information is for performing mobility management of the second device.

13. The apparatus according to claim 12, wherein the first protocol entity of the first device comprises a radio resource control (RRC) entity.

14. The apparatus according to claim 11, wherein the first information comprises one or more of: a synchronization signal and physical broadcast channel block (SSB)-based measurement timing configuration (SMTC) corresponding to each of the plurality of satellites, a time offset of the SMTC, ephemeris information of a satellite corresponding to a satellite providing a network service for the second device in a first time length, a first distance threshold for determining whether the second device performs registration area update, time at which the second device performs satellite reselection, time at which the second device performs satellite switching, a location at which the second device performs satellite reselection, a location at which the second device performs satellite switching, or paging configuration information of the second device in the cell corresponding to the plurality of satellites.

15. The apparatus according to claim 12, wherein the first protocol entity of the first device comprises a non-access stratum (NAS) entity.

16. The apparatus according to claim 15, wherein the first information comprises registration area update information indicating whether a registration area of the second device is successfully updated.

17. The apparatus according to claim 15, wherein the apparatus is further caused to:
receive, by the first device, second information from the first satellite, wherein the second information indicates to update a location of the second device; and
process, by the first device, the second information by using the NAS entity.

18. The apparatus according to claim 11, wherein the first protocol entity of the first device comprises a service data adaptation protocol (SDAP) entity.

19. The apparatus according to claim 11, wherein the first protocol entity of the first device further comprises a packet data convergence protocol (PDCP) entity.

20. The apparatus according to claim 11, wherein the first protocol entity of the first device further comprises a radio link control (RLC) entity.
